(19) United States
(12) Patent Application Publication
(10) Pub. No.: US 2026/0113704 A1
(43) Pub. Date: Apr. 23, 2026

(54) METHODS AND APPARATUS FOR OPERATING RADIO BASE STATIONS

(71) Applicant: Nokia Solutions and Networks Oy, Espoo (FI)

(72) Inventor: Lorenzo MAGGI, Massy (FR)

(21) Appl. No.: 19/147,625

(22) PCT Filed: Jan. 18, 2023
(86) PCT No.: PCT/IB2023/050442

§ 371 Date: Jul. 11, 2025

(51) Int. Cl. H04W 52/02; H04W 28/16

(52) U.S. Cl. CPC H04W 52/0206; H04W 28/16

(57) ABSTRACT

A method includes determining key performance indicators (KPIs) indicative of operating parameters of a base station and determining KPI constraints corresponding to the KPIs and indicative of constraints on the operating parameters of the base station. The method includes determining, for a present resource configuration of the base station, whether present values of the KPIs correspond to the KPI constraints and determining a KPI budget. The method includes, determining, for future resource configurations, a probability that future values of the KPIs correspond to the KPI constraints and determining a future energy consumption of the future resource configurations. The method includes determining a next resource configuration based on a combination of the future energy consumption of the future resource configurations, the probability that the future values of the KPIs correspond to the KPI constraints, and the KPI budget, and reconfiguring resources of the base station based on the next resource configuration.

### TECHNICAL FIELD

An example embodiment of the present disclosure generally relates to communication systems and, more particularly, to adaptively conserving power at a base transceiver station.

### BACKGROUND

A Radio Access Network (RAN) enables communication sessions between two or more entities such as user equipment (UE), base transceiver stations (hereinafter, “base stations”), Network Functions (NF), and/or other nodes by providing connectivity between the various entities involved in a communication path of a communication system via a radio link. A RAN associated with a communication system may include, for example, a communication network and one or more compatible communication devices. Communication systems continue to evolve to expand network usage, to provide improved security, and/or to provide users with improved network services. For instance, fourth generation (4G) wireless mobile telecommunications technology, also known as Long Term Evolution (LTE) technology, was designed to provide high-capacity mobile multimedia with high data rates particularly for human interaction. Next generation or fifth generation new radio (5G NR) technology is intended to be used not only for human interaction, but also for machine type communications in so-called Internet of Things (IoT) networks.

In LTE, base stations can be configured as access points, or nodes, which are referred to as Evolved Node Bs (eNBs) and provide wireless access for 4G/LTE capable devices within a coverage area or cell. Similarly, in 5G NR, base stations can be configured as access points which are referred to as Next Generation Node Bs (gNBs) and provide wireless access for 5G capable devices within a coverage area or cell. However, in many circumstances, a base station can be a radio base station that is deployed in a multiple radio access technology (multi-RAT) configuration that supports communication network connectivity for 4G/LTE capable UE devices, 5G capable UE devices, and/or UE devices configured to communicate via older communication network protocols such as 2G and 3G. Modern UEs are capable of communicating via multiple technologies simultaneously (e.g., modern mobile phones support both LTE and 5G connectivity) and, as such, operators typically construct RANs by deploying many base stations configured in a multi-RAT configuration in order to provide network coverage and seamless connectivity for such modern UEs.

According to the Global System for Mobile Communications Association (GSMA), the energy consumption of a RAN accounts for 20-25% of the network Total Cost of Ownership (TCO), and mobile network operators globally spend nearly 17 billion dollars per year on energy alone. Furthermore, the energy needs of future networks are likely to exceed current demand due to increased cellular densities, massive multiple input, multiple output (MIMO) radio antenna technologies and further advances in the telecommunications field. All of this, coupled with the need to reduce carbon emissions to zero by mid-century, makes energy savings (ES) an essential feature of any large-scale infrastructure.

### SUMMARY

Methods, apparatuses, and computer program products are provided in accordance with an example embodiment for operating radio base stations.

In one example embodiment, a computer-implemented method includes determining a plurality of key performance indicators (KPIs) indicative of a plurality of operating parameters of a base station. The computer-implemented method also includes determining a plurality of KPI constraints corresponding to the plurality of KPIs and indicative of constraints on the operating parameters of the base station. The computer-implemented method also includes, for a present time step, determining, for a present resource configuration of the base station during the present time step, whether present values of the KPIs correspond to the KPI constraints and determining, based on whether the present values of the KPIs correspond to the KPI constraints, a KPI budget. The computer-implemented method also includes, for a future time step subsequent to the present time step, determining, for each of a plurality of future resource configurations of the base station, a probability that future values of the KPIs correspond to the KPI constraints and determining a future energy consumption of the future resource configuration. The computer-implemented method also includes determining a next resource configuration of the base station based on a combination of the future energy consumption of each of the plurality of future resource configurations, the probability that, for each of the plurality of future resource configurations, the future values of the KPIs correspond to the KPI constraints, and the KPI budget. The computer-implemented method also includes causing one or more resources of the base station to be reconfigured based on the next resource configuration.

In a computer-implemented method of an example embodiment determining the next resource configuration includes solving a long-term stochastic problem to minimize an objective function indicative of a linear combination of the future energy consumption at the base station and a penalty for violation of the KPI budget.

The computer-implemented method may also include determining, based on whether the present values of the KPIs correspond to the KPI constraints, a frequency of a correspondence between the present value of the KPIs and the KPI constraints, and determining a minimum acceptable frequency of the correspondence between the present values of the KPIs and the KPI constraints.

Determining the KPI budget in accordance with an example embodiment includes determining a difference between the frequency of the correspondence between the present value of the KPIs and the KPI constraints and the minimum acceptable frequency of the correspondence between the present values of the KPIs and the KPI constraints.

In a computer-implemented method of an example embodiment, determining, for each of the plurality of future resource configurations, the probability that future values of the KPIs correspond to the KPI constraints is based on the present resource configuration, a plurality of present radio conditions, and a present network load.

Causing the one or more resources associated with the base station to be reconfigured based on the next resource configuration may include activating or deactivating a frequency band. In an example embodiment, causing the one or more resources of the base station to be reconfigured based on the next resource configuration includes activating or deactivating at least one radiating element of an antenna system of the base station.

Determining the next resource configuration in one example embodiment is based on a resource configuration switch penalty that limits switching of the present resource configuration to the next resource configuration. In an example embodiment, the next resource configuration is determined based on the combination of the future energy consumption, the penalty for violation of the KPI budget and the resource configuration switch penalty. A sliding time window may be divided in accordance with an example embodiment into a plurality of time steps including the present time step and the future time step subsequent to the present time step.

In another example embodiment, an apparatus including at least one processor and at least one memory is provided with the at least one memory storing instructions that, when executed by the at least one processor, cause the at least one processor to determine a plurality of key performance indicators (KPIs) indicative of a plurality of operating parameters of a base station. The apparatus also includes instructions that cause the at least one processor to determine a plurality of KPI constraints corresponding to the plurality of KPIs and indicative of constraints on the operating parameters of the base station. The apparatus also includes instructions to, for a present time step, determine, for a present resource configuration of the base station during the present time step, whether present values of the KPIs correspond to the KPI constraints and determine, based on whether the present values of the KPIs correspond to the KPI constraints, a KPI budget. The apparatus also includes instructions to, for a future time step subsequent to the present time step, determine, for each of a plurality of future resource configurations of the base station, a probability that future values of the KPIs correspond to the KPI constraints and determine a future energy consumption of the future resource configuration. The apparatus also includes instructions to determine a next resource configuration of the base station based on a combination of the future energy consumption of each of the plurality of future resource configurations, the probability that, for each of the plurality of future resource configurations, the future values of the KPIs correspond to the KPI constraints, and the KPI budget. The apparatus also includes instructions to cause one or more resources of the base station to be reconfigured based on the next resource configuration.

The instructions to determine the next resource configuration may include instructions to solve a long-term stochastic problem to minimize an objective function indicative of a linear combination of the future energy consumption at the base station and a penalty for violation of the KPI budget. The apparatus of an example embodiment also includes instructions that cause the apparatus to determine, based on whether the present values of the KPIs correspond to the KPI constraints, a frequency of a correspondence between the present value of the KPIs and the KPI constraints, and determine a minimum acceptable frequency of the correspondence between the present values of the KPIs and the KPI constraints.

The instructions to determine the KPI budget may include instructions to determine a difference between the frequency of the correspondence between the present value of the KPIs and the KPI constraints and the minimum acceptable frequency of the correspondence between the present values of the KPIs and the KPI constraints. In an example embodiment, the instructions to determine, for each of the plurality of future resource configurations, the probability that future values of the KPIs correspond to the KPI constraints are based on the present resource configuration, a plurality of present radio conditions, and a present network load.

The instructions to cause the one or more resources associated with the base station to be reconfigured based on the next resource configuration further cause the apparatus to activate or deactivate a frequency band. In an example embodiment, the instructions to cause the one or more resources of the base station to be reconfigured based on the next resource configuration further cause the apparatus to activate or deactivate at least one radiating element of an antenna system of the base station.

The instructions to determine the next resource configuration may be based on a resource configuration switch penalty that limits switching of the present resource configuration to the next resource configuration. In an example embodiment, the next resource configuration is determined based on the combination of the future energy consumption, the penalty for violation of the KPI budget and the resource configuration switch penalty. A sliding time window may be divided into a plurality of time steps including the present time step and the future time step subsequent to the present time step.

In a further example embodiment, a computer program product is provided that includes at least one non-transitory computer-readable storage medium having computer-executable program code instructions stored therein. The computer-executable program code instructions also include program code instructions to determine a plurality of key performance indicators (KPIs) indicative of a plurality of operating parameters of a base station. The computer program product also includes program code instructions configured to determine a plurality of KPI constraints corresponding to the plurality of KPIs and indicative of constraints on the operating parameters of the base station. The computer program product also includes program code instructions configured to, for a present time step, determine, for a present resource configuration of the base station during the present time step, whether present values of the KPIs correspond to the KPI constraints and determine, based on whether the present values of the KPIs correspond to the KPI constraints, a KPI budget. The computer program product also includes program code instructions configured to, for a future time step subsequent to the present time step, determine, for each of a plurality of future resource configurations of the base station, a probability that future values of the KPIs correspond to the KPI constraints and determine a future energy consumption of the future resource configuration. The computer program product also includes program code instructions configured to determine a next resource configuration of the base station based on a combination of the future energy consumption of each of the plurality of future resource configurations, the probability that, for each of the plurality of future resource configurations, the future values of the KPIs correspond to the KPI constraints, and the KPI budget. The computer program product also includes program code instructions configured to cause one or more resources of the base station to be reconfigured based on the next resource configuration.

The computer program product further includes where the computer-executable instructions to determine the next resource configuration further include program code instructions to solve a long-term stochastic problem to minimize an objective function indicative of a linear combination of the future energy consumption at the base station and a penalty for violation of the KPI budget.

The computer program product further includes where the computer-executable instructions further include program code instructions to determine, based on whether the present values of the KPIs correspond to the KPI constraints, a frequency of a correspondence between the present value of the KPIs and the KPI constraints, and determine a minimum acceptable frequency of the correspondence between the present values of the KPIs and the KPI constraints.

The computer program product further includes where the computer-executable instructions to determine the KPI budget further include program code instructions to determine a difference between the frequency of the correspondence between the present value of the KPIs and the KPI constraints and the minimum acceptable frequency of the correspondence between the present values of the KPIs and the KPI constraints.

The computer program product further includes where the computer-executable instructions to determine, for each of the plurality of future resource configurations, the probability that future values of the KPIs correspond to the KPI constraints are based on the present resource configuration, a plurality of present radio conditions, and a present network load.

The computer program product further includes where the computer-executable instructions to cause the one or more resources associated with the base station to be reconfigured based on the next resource configuration further comprise program code instructions to activate or deactivate a frequency band.

The computer program product further includes where the computer-executable instructions to cause the one or more resources of the base station to be reconfigured based on the next resource configuration further comprise program code instructions to activate or deactivate at least one radiating element of an antenna system of the base station.

The computer program product further includes where the computer-executable instructions to determine the next resource configuration are based on a resource configuration switch penalty that limits switching of the present resource configuration to the next resource configuration.

The computer program product further includes where the next resource configuration is determined based on the combination of the future energy consumption, the penalty for violation of the KPI budget and the resource configuration switch penalty.

The computer program product further includes where the present time step and the future time step subsequent to the present time step are associated with a sliding time window, and where the respective present time step and the respective future time step associated with the sliding time window can be defined in increments of seconds, minutes, hours, or a combination of said seconds, minutes, or hours.

In another example embodiment, an apparatus is provided. The apparatus provides means for determining a plurality of key performance indicators (KPIs) indicative of a plurality of operating parameters of a base station. The apparatus also includes means for determining a plurality of KPI constraints corresponding to the plurality of KPIs and indicative of constraints on the operating parameters of the base station. The apparatus also includes, for a present time step, means for determining, for a present resource configuration of the base station during the present time step, whether present values of the KPIs correspond to the KPI constraints and determining, based on whether the present values of the KPIs correspond to the KPI constraints, a KPI budget. The apparatus also includes, for a future time step subsequent to the present time step, means for determining, for each of a plurality of future resource configurations of the base station, a probability that future values of the KPIs correspond to the KPI constraints and determining a future energy consumption of the future resource configuration. The apparatus also includes means for determining a next resource configuration of the base station based on a combination of the future energy consumption of each of the plurality of future resource configurations, the probability that, for each of the plurality of future resource configurations, the future values of the KPIs correspond to the KPI constraints, and the KPI budget. The apparatus also includes means for causing one or more resources of the base station to be reconfigured based on the next resource configuration.

The means for determining the next resource configuration may include means for solving a long-term stochastic problem to minimize an objective function indicative of a linear combination of the future energy consumption at the base station and a penalty for violation of the KPI budget. In an example embodiment, the apparatus further includes means for determining, based on whether the present values of the KPIs correspond to the KPI constraints, a frequency of a correspondence between the present value of the KPIs and the KPI constraints, and determining a minimum acceptable frequency of the correspondence between the present values of the KPIs and the KPI constraints.

The means for determining the KPI budget may include means for determining a difference between the frequency of the correspondence between the present value of the KPIs and the KPI constraints and the minimum acceptable frequency of the correspondence between the present values of the KPIs and the KPI constraints. In an example embodiment, the means for determining, for each of the plurality of future resource configurations, the probability that future values of the KPIs correspond to the KPI constraints is based on the present resource configuration, a plurality of present radio conditions, and a present network load.

The means for causing the one or more resources associated with the base station to be reconfigured based on the next resource configuration may include means for activating or deactivating a frequency band. In an example embodiment, the means for causing the one or more resources of the base station to be reconfigured based on the next resource configuration include means for activating or deactivating at least one radiating element of an antenna system of the base station.

The means for determining the next resource configuration may be based on a resource configuration switch penalty that limits switching of the present resource configuration to the next resource configuration. In an example embodiment, the next resource configuration is determined based on the combination of the future energy consumption, the penalty for violation of the KPI budget and the resource configuration switch penalty. A sliding time window may be divided into a plurality of time steps including the present time step and the future time step subsequent to the present time step.

### BRIEF DESCRIPTION OF THE DRAWINGS

Having thus described certain example embodiments of the invention in general terms, reference will now be made to the accompanying drawings, which are not necessarily drawn to scale, and wherein:

FIG. 1 is a block diagram of a base station in accordance with one or more example embodiments of the present disclosure;

FIG. 2 illustrates a sliding time window corresponding to three timescales associated with a Markov Decision Process (MDP) used to reduce power consumption of a base station in accordance with one or more example embodiments of the present disclosure;

FIG. 3 illustrates a key performance indicator (KPI) budget violation penalty associated with a base station in accordance with one or more example embodiments of the present disclosure;

FIG. 4 illustrates a flowchart depicting a method for reducing power consumption at a base station subject to user-defined KPI constraints via an MDP in accordance with one or more example embodiments of the present disclosure;

FIG. 5 illustrates another flowchart depicting a method for reducing power consumption at a base station subject to user-defined KPI constraints via an MDP in accordance with one or more example embodiments of the present disclosure;

FIG. 6 illustrates an example approximation of per-cell power consumption associated with a base station in accordance with one or more example embodiments of the present disclosure;

FIG. 7 illustrates predictions associated with the KPI compliance and power consumption of a base station as calculated via KPI compliance and power consumption functions while considering one resource type associated with the base station in accordance with one or more example embodiments of the present disclosure;

FIG. 8 illustrates the structure of a baseline greedy policy associated with a base station used to compare the results of applying various embodiments of the present disclosure;

FIG. 9 illustrates the performance of a baseline greedy policy considering one resource type as applied to a base station over time and generated via predicted KPI compliance probabilities in accordance with one or more example embodiments of the present disclosure;

FIG. 10 illustrates the structure of an MDP policy in which there is no resource configuration switch penalty function imposed to reduce the number of resource configuration switches associated with a base station in accordance with one or more example embodiments of the present disclosure;

FIG. 11 illustrates the performance of an MDP policy in which there is no resource configuration switch penalty function imposed to reduce the number of resource configuration switches associated with a base station in accordance with one or more example embodiments of the present disclosure;

FIG. 12 illustrates the structure of an MDP policy in which there is a resource configuration switch penalty function imposed to reduce the number of resource configuration switches associated with a base station in accordance with one or more example embodiments of the present disclosure;

FIG. 13 illustrates the performance of an MDP policy in which there is a resource configuration switch penalty function imposed to reduce the number of resource configuration switches associated with a base station in accordance with one or more example embodiments of the present disclosure;

FIG. 14 illustrates predictions associated with the KPI compliance and power consumption of a base station as calculated via KPI compliance and power consumption functions while considering two resource types associated with the base station in accordance with one or more example embodiments of the present disclosure;

FIG. 15 illustrates the performance of a baseline greedy policy considering two resource types as applied to a base station over time and generated via predicted KPI compliance probabilities in accordance with one or more example embodiments of the present disclosure;

FIG. 16 illustrates the performance of an MDP policy considering two resource types associated with a base station and in which there is no resource configuration switch penalty function imposed to reduce the number of resource configuration switches associated with the base station in accordance with one or more example embodiments of the present disclosure; and

FIG. 17 illustrates the performance of an MDP policy considering two resource types associated with a base station and in which there is a resource configuration switch penalty function imposed to reduce the number of resource configuration switches associated with the base station in accordance with one or more example embodiments of the present disclosure.

### DETAILED DESCRIPTION

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Additionally, the terms “power,” “load,” “energy,” and similar terms may be used interchangeably to refer to a measurable amount of electricity consumed by a component of a radio access network (RAN) such as a base station. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As defined herein, a “computer-readable storage medium,” which refers to a physical storage medium (e.g., volatile, or non-volatile memory device), may be differentiated from a “computer-readable transmission medium,” which refers to an electromagnetic signal.

Third generation partnership project (3GPP)₅th generation (5G) technology is a next generation of radio systems and network architecture that can deliver extreme broadband and ultra-robust, low latency connectivity. 5G technology improves a variety of telecommunication services offered to the end users and supports massive broadband that delivers gigabytes of bandwidth per second on demand for the uplink and downlink transmissions. As one example, next generation communication systems may be configured to use virtualized RAN functions and core network functions. As another example, next generation systems may use a Service Based Architecture (SBA), e.g., a system architecture in which the system functionality is achieved using a set of Network Functions (NFs) providing services to other NFs authorized to access their services. The 5G network may be configured to support NFs via a Network Repository Function (NRF). For example, an NRF may be configured to maintain a list of available NFs to facilitate service registration and/or discovery in an instance in which a user equipment (UE) attempts to access one or more services provided by one or more network devices.

Example communication systems, frameworks, and/or associated techniques of the present disclosure may be configured to provide energy savings at a base station subject to user-defined key performance indicator (KPI) constraints by solving a long-term stochastic problem that can be modeled as a Markov Decision Process (MDP). It should be understood that the present disclosure is not limited to the particular types of communication systems and/or processes disclosed. For example, although illustrated in the context of wireless cellular systems utilizing 3GPP system elements such as a 3GPP next generation core network, the disclosed embodiments can be adapted in a straightforward manner to a variety of other types of communication systems. Additionally, while the present disclosure may describe certain embodiments in conjunction with a 5G communications system, other embodiments also apply to and comprise other networks and network technologies, such as 3G, 4G, Long Term Evolution (LTE), 6G, etc., without limitation.

In accordance with an illustrative embodiment implemented in a 5G communication system environment, one or more 3GPP standards, specifications, and/or protocols provide further explanation of user equipment and core network elements/entities/functions and/or operations performed by the user equipment and the core network elements/entities/functions, e.g., the 3GPP System Aspects (SA) Working Group 5 (3GPP SA5), the 3GPP RAN 3. Other 3GPP standards, specifications and/or protocols provide other conventional details that one of ordinary skill in the art will realize. However, while illustrative embodiments are well-suited for implementation associated with the above-mentioned 3GPP standards, alternative embodiments are not necessarily intended to be limited to any particular standards.

In a wireless communication system, at least a part of a communication session between at least two stations occurs over a wireless link. Examples of wireless systems include public land mobile networks (PLMN), satellite-based communication systems and different wireless local networks, for example wireless local area networks (WLAN). Some wireless systems can be divided into cells and are therefore often referred to as cellular systems.

A user may access the communication system using a communication device or terminal. A communication device of a user may be referred to as a UE or a user device. A communication device may include a signal receiving and transmitting apparatus for establishing communication, directly or indirectly, with other devices, users, networks, and so on. The communication device may access a frequency layer provided by a station, for example a base station of a cell and transmit and/or receive communications on the frequency layer. For example, a base station deployed in a multi-RAT configuration can facilitate communication via multiple frequency layers associated with multiple respective communications technologies (e.g., 4G or 5G technologies).

In some instances, the base stations may consume most of the energy used by a network, such as a RAN. The majority of the energy is consumed by the power amplifiers responsible for powering the antenna system associated with the base station, however, baseband processing and network switching also consume considerable amounts of energy. In order to address ever-increasing energy costs and various environmental concerns, methods, apparatuses, and computer program products are provided for reducing energy consumption at a base station by solving a long-term stochastic problem that can be modeled as an MDP that minimizes an objective function in the long-term while adhering to user-defined KPI constraints. In this regard, the objective function is a linear combination of energy consumption at a base station and a penalty for KPI budget violation Various embodiments of the present disclosure can, over time, jointly optimize the configuration of different types of resources associated with a base station (e.g., frequency layers belonging to different technologies such as 4G, 5G, and/or various transmission paths) in order to reduce and/or minimize power consumption of the base station, reduce and/or minimize occurrences of KPIs dropping below user-defined threshold(s), and limit the frequency of a resource configuration switch. An embodiment of the present disclosure is self-contained and can be embedded at an apparatus, such as the base station, such that the methods described herein can be executed by one or more components associated with the apparatus, e.g., the base station.

By solving a long-term stochastic problem modeled as an MDP in order to regulate the configuration of the resources and components of a base station (e.g., various transceiver components, power system components, and/or antenna system components), it is possible to improve performance of the base station while also reducing the power consumption of the base station. Furthermore, applying an MDP to regulate the configuration of the resources and components of one or more base stations associated with a RAN can improve the operation of an associated communications network while reducing the overall power consumption of the RAN.

At a general level, an MDP is a stochastic decision-making process that relies on mathematics to model and, in some circumstances, execute decisions, or actions, for a system based on the current state of the system and a predefined reward/penalty system in order to determine an optimal policy, or strategy, by which the system can operate. There are four main components of an MDP known as states, actions, transition probabilities (also known as state transitions), and rewards/costs. The policy (or strategy) of an MDP determines a desired or optimal action for the system to execute given a current state such that the system can gain am enhanced or maximum reward (or incur a reduced or minimum cost). An MDP embodies the concept of the Markov Property which posits that a future state can only be determined only from a present state. The manner in which an embodiment of the present disclosure employs MDPs to reduce power consumption of a base station while adhering to user-defined KPI constraints will be described in detail herein.

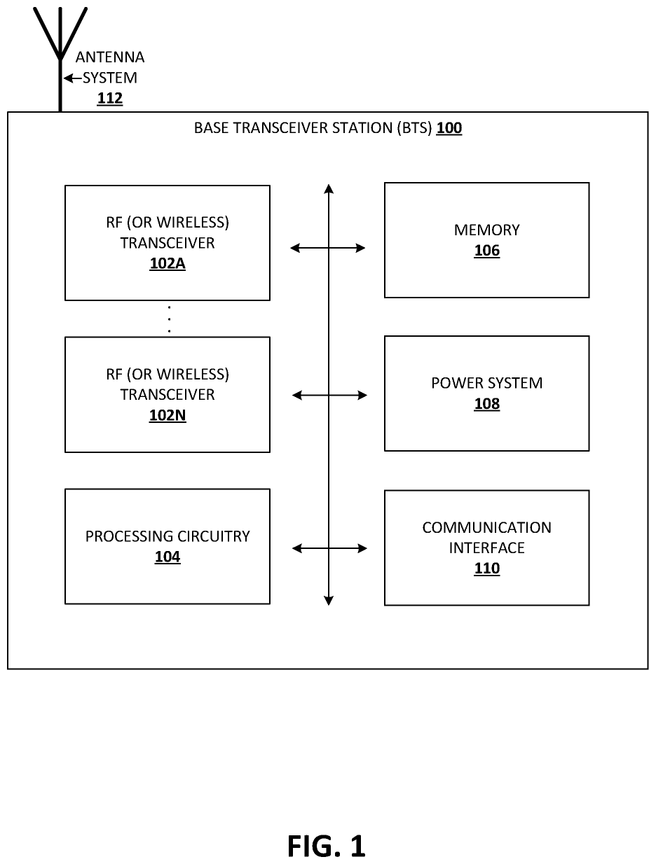

FIG. 1 is a block diagram of a base station (also known as a base transceiver station) 100 according to an example implementation. The base station 100 can include, for example, one or more RF (radio frequency) and/or wireless transceivers 102A-N, where each wireless transceiver includes a transmitter to transmit signals and a receiver to receive signals. Although depicted and referenced herein as a transceiver, the base station can, instead, include a discrete transmitter and/or receiver in another example embodiment. The base station 100 also includes processing circuitry 104, a memory 106, power system 108, and an antenna system 112. In one or more embodiments, the base station 100 can be a radio base station deployed in a multiple radio access technology (multi-RAT) configuration such that the base station 100 can support communication network connectivity for one or more UE devices configured to communicate on one or more respective networks (e.g., UEs configured to communicate via 4G/LTE and/or 5G cellular networks).

In circumstances in which the base station 100 is deployed in a multi-RAT configuration, the one or more RF and/or wireless transceivers 102A-N associated with the base station 100 can be transceivers of any type. For example, a base station 100 can have one or more RF and/or wireless transceivers 102A-N for facilitating communication on a 4G/LTE network, one or more RF and/or wireless transceivers 102A-N for facilitating communication on a 5G network, and/or the like. Additionally, the base station 100 can comprise a combination of one or more RF and/or wireless transceivers 102A-N for facilitating communication on various respective communication networks. The one or more RF and/or wireless transceiver(s) 102A/102B can receive signals or data and/or transmit or send signals and/or data. In various embodiments, processing circuitry 104 (and, in some scenarios, the RF and/or wireless transceivers 102A-N) can control the RF and/or wireless transceivers 102A-N to receive, send, broadcast, or transmit signals and/or data.

As such, the base station 100 comprises an antenna system 112 which can be configured to transmit and/or receive signals generated by the one or more RF and/or wireless transceivers 102A-N. The antenna system 112 can comprise, but is not limited to, one or more directional antennas, one or more omnidirectional antennas, or one or more leaky coaxial antennas comprising one or more radiating elements (e.g., dipole elements). Additionally or alternatively, the antenna system 112 can comprise one or more antenna elements comprising one or more embedded RF transceivers configured in various sized arrays. For example, the base station 100 can be configured as an active antenna system (AAS) featuring a 4×4, 8×8, and/or any other configuration of antenna array.

The processing circuitry 104 can be embodied in a number of different ways. For example, the processing circuitry 104 can be embodied as one or more of various hardware processing means including at least one processor, such as a coprocessor, a microprocessor, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 104 can include one or more processing cores configured to perform independently. A multi-core processor can enable multiprocessing within a single physical package. Additionally or alternatively, the processing circuitry 104 can include one or more processors configured in tandem via the bus to enable independent execution of instructions, pipelining and/or multithreading.

In various embodiments, the processing circuitry 104 can be embodied by, or can be integrated with, a base station controller (BSC) capable of controlling and/or reconfiguring the various components associated with the base station 100 such as, for example, the one or more RF and/or wireless transceivers 102A-N, the power system 108, and/or the antenna system 112. For example, based on the one or more computer program instructions comprised within the memory 106, the processing circuitry 104 can cause a BSC associated with the base station 100 to control and/or reconfigure the one or more RF and/or wireless transceivers 102A-N, the power system 108, and/or the antenna system 112.

In an example embodiment, the processing circuitry 104 can be configured to execute instructions stored in the memory 106 or otherwise accessible to the processing circuitry 104. Alternatively or additionally, the processing circuitry 104 can be configured to execute hard coded functionality. As such, whether configured by hardware or software methods, or by a combination thereof, the processing circuitry 104 can represent an entity (e.g., physically embodied in circuitry) capable of performing operations according to an embodiment of the present disclosure while configured accordingly. Thus, for example, when the processing circuitry 104 is embodied as an ASIC, FPGA or the like, the processing circuitry 104 can be specifically configured hardware for conducting the operations described herein. Alternatively, as another example, when the processing circuitry 104 is embodied as an executor of software instructions, the instructions can specifically configure the processing circuitry 104 to perform the algorithms and/or operations described herein when the instructions are executed. However, in some cases, the processing circuitry 104 can be a processor of a specific device (e.g., a pass-through display or a mobile terminal) configured to employ an embodiment of the present disclosure by further configuration of the processing circuitry 104 by instructions for performing the algorithms and/or operations described herein. The processing circuitry 104 can include, among other things, a clock, an arithmetic logic unit (ALU) and logic gates configured to support operation of the processing circuitry 104.

The processing circuitry 104 can make decisions or determinations, generate frames, packets, or messages for transmission, decode received frames or messages for further processing, and other tasks or functions described herein. The processing circuitry 104, which can be a baseband processor, for example, can generate messages, packets, frames, or other signals for transmission via wireless transceivers 102A-N. The processing circuitry 104 can control transmission of signals or messages over a wireless network, and can control the reception of signals or messages, etc., via a wireless network (e.g., after being down-converted by wireless transceiver 102A, for example).

The processing circuitry 104 can be programmable and capable of executing software and/or other instructions stored in the memory 106 and/or on other computer media to perform the various tasks and functions associated with adaptively saving energy at a base station 100 that is subject to user-defined KPI constraints using an MDP as described herein. The processing circuitry 104 can be (or can include), for example, hardware, programmable logic, a programmable processor that executes software or firmware, and/or any combination of these. Using other terminology, processing circuitry 104 and wireless transceivers 102A-N together can be considered as a wireless transmitter/receiver system, for example.

Additionally, the processing circuitry 104 can execute software and instructions and can provide control for other systems not shown in FIG. 1, such as controlling input/output devices (e.g., display, keypad), and/or can execute software for one or more applications that can be provided on the base station 100, such as, for example, an email program, audio/video applications, a word processor, a Voice over IP application, or other application or software.

As described herein, the memory 106 can store one or more computer program instructions configured to execute the one or more processes, tasks, and/or functions described herein. The memory 106 can comprise, for example, volatile memory, non-volatile memory, or some combination thereof. In this regard, the memory 106 can comprise a non-transitory computer-readable storage medium. Although illustrated in FIG. 1 as a single memory, the memory 106 can comprise a plurality of memories. In various example embodiments, the memory 106 can comprise a hard disk, random access memory, cache memory, flash memory, a compact disc read only memory (CD-ROM), digital versatile disc read only memory (DVD-ROM), an optical disc, circuitry configured to store information, or some combination thereof. The memory 106 can be configured to store information, data, applications, instructions, or the like for enabling the base station 100 to carry out various functions in accordance with various example embodiments. For example, in some example embodiments, the memory 106 is configured to buffer input data for processing by the processing circuitry 104. Additionally or alternatively, the memory 106 can be configured to store program instructions for execution by the processing circuitry 104. The memory 106 can store information in the form of static and/or dynamic information.

The power system 108 comprises one or more components configured to provide and/or regulate the power supply for the base station 100. In one or more embodiments, the power system 108 can comprise, but is not limited to, one or more power amplifiers (PA), a power supply from an electrical grid infrastructure, one or more battery backups, and/or one or more cooling devices. The one or more PAs are configured to boost and/or regulate low-level RF signals into high-level signals. The one or more PAs comprised in the power system 108 can be of various amplifier classes and can be configured to drive one or more antennas (e.g., such as in the antenna system 112) associated with a particular type of communication network. For example, in some embodiments, a laterally diffused metal oxide semiconductor field effect transistor (MOSFET) (LDMOS) radio frequency (RF) power amplifier can be used to boost RF signals for an RF transceiver 102A configured for facilitating communication on a 4G/LTE communication network.

In some instances, a base station 100 may be powered (by way of the power system 108) using an electrical grid infrastructure. However, in some other instances, the base station 100 can be powered by a stand-alone power source including, but not limited to, a wind generator, solar panel array, and/or a combustible fuel-based power generator. In one or more embodiments, the power system 108 comprises one or more battery backups to mitigate contingencies in which the base station 100 loses connection to the primary source of power. In various embodiments, the power system 108 also comprises a cooling system configured to keep the various components of the power system 108 working within safe operating temperatures.

In various embodiments, the power system 108 can collect, measure, transmit, and/or store power usage data associated with a particular base station 100. For example, the power system 108 can collect power usage data associated with the base station 100 and transmit the power usage data to the processing circuitry 104. Based on the power usage data, the processing circuitry 104 can execute various actions associated with the base station 100. For example, based on the power usage data, the processing circuitry 104 can execute various computer program instructions (e.g., instructions comprised in the memory 106) to control and/or reconfigure the one or more RF and/or wireless transceivers 102A-N, the power system 108, and/or the antenna system 112 associated with the base station 100. Additionally, the power system 108 can store the power usage data associated with the base station 100 in the memory 106.

The base station 100 can optionally include the communication interface 110. The communication interface 110 can be any means such as a device or circuitry embodied in either hardware or a combination of hardware and software that is configured to receive and/or transmit data from/to a network and/or any other device or module in communication with the apparatus. In this regard, the communication interface 110 can include, for example, an antenna (or multiple antennas) and supporting hardware and/or software for enabling communications with a wireless communication network. Additionally or alternatively, the communication interface 110 can include the circuitry for interacting with the antenna system 112 to cause transmission of signals via the RF and/or wireless transceivers 102A-N or to handle receipt of signals received via the RF and/or wireless transceivers 102A-N. In some environments, the communication interface 110 can alternatively or also support wired communication. As such, for example, the communication interface 110 can include a communication modem and/or other hardware/software for supporting communication via cable, digital subscriber line (DSL), universal serial bus (USB) or other mechanisms.

Various embodiments of the present disclosure combine various techniques directed towards reconfiguring one or more components, or resources, associated with a base station (e.g., base station 100) in order to reduce the power consumption of the base station while simultaneously adhering to user-defined KPI constraints. For example, various embodiments combine multiple techniques such as cell switch-off and MIMO antenna muting techniques. In executing a cell switch-off technique, various frequency layers of a particular telecommunications technology (e.g., frequency layers associated with 4G or 5G technologies) can be deactivated in order to reduce power consumption of the base station 100. In executing MIMO muting, various portions of an antenna array associated with the base station 100 are reconfigured and the active size of the antenna array is scaled down such that part of the antenna array is active and part of the antenna array is inactive (e.g., by disabling one or more antenna elements). Such a MIMO muting technique considerably reduces the amount of power consumed by the PAs responsible for powering the antenna array elements (e.g., one or more power amplifiers comprised in the power system 108 associated with the base station 100).

In one example, various resource types r associated with the base station 100 can be indexed, and there can exist R different resource types indexed by r=1, . . . , R. For instance, in an instance in which both cell switch-off and MIMO muting techniques are being applied on a base station 100 deployed in a multiple radio access technology (multi-RAT) configuration, there are R=3 resource types:

$$r = 1 \text{:} frequency layers in 4 G$$

$$r = 2 \text{:} frequency layers in 5 G$$

$$r = 3 \text{:} TXs$$

where the TXs (transmitters) can be antenna elements (e.g., radiating elements) associated with a respective radio frequency (RF) transmission path.

Each resource type r=1, . . . , R can be in a different configuration state, indexed by n^{r}=1, . . . , N^{r}, where N^{r} is the number of available configurations for resource r. Index n^{r} may increase with an increase in the number of active resources of type r (hence, n^{r} is not necessarily the number of active resources). In practice, if resource r:=“cell in xG”: as nᵣ increases, new xG (e.g., 4G or 5G) frequency layers are activated. If resource r:=“TX”: as nᵣ increases, new radiating elements are activated. The processing circuitry 104 of the base station 100 can choose to change a resource configuration at time steps t=1, 2, . . . T (e.g., every few seconds or minutes) of a sliding time window and nₜ^{r} can be understood to be the configuration index of resource type r at time t.

In one or more embodiments, an end user associated with the base station 100 (e.g., a mobile network operator) can define one or more key performance indicators (KPIs) associated with the operating performance of the base station 100. Alternatively, the KPI(s) can be predefined. KPIs can include, but are not limited to, hand over success rate (HOSR), inter-RAT handover (IRAT), paging success rate (PSR), standalone dedicated control channel (SDCCH) availability rate, SDCCH congestion rate, SDCCH call drop rate, traffic channel (TCH) availability, TCH call drop rate, TCH congestion rate, TCH assignment success rate, call setup success rate (CSSR), call complete success rate (CCSR), call setup delay, and/or various KPIs associated with the various hardware components (e.g., RF (or wireless) transceiver 102A, power system 108, antenna system 112) associated with the base station 100.

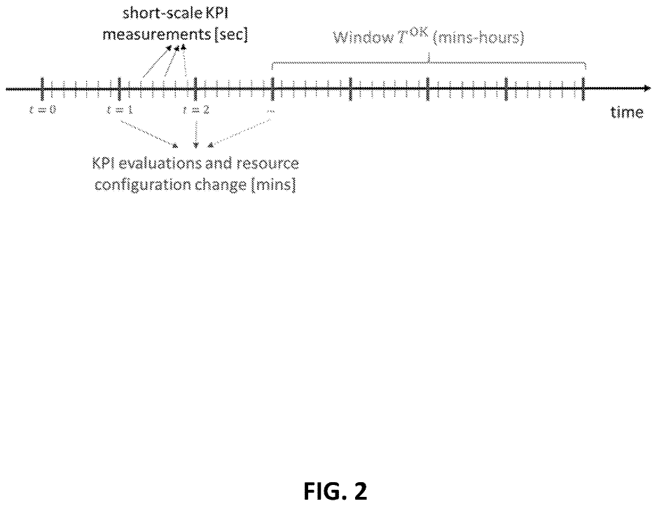

FIG. 2 illustrates a sliding time window corresponding to three timescales used with the MDP to reduce power consumption of a base station in accordance with one or more example embodiments of the present disclosure. The sliding time window defines a plurality of sequential time steps. The processing circuitry 104 of the base station 100 monitors a list of KPIs indexed by k=1, . . . , K. At time step t=1, 2, . . . T of a sliding time window the base station 100 estimates the current value of the k-th KPI, denoted by

$${KPI}_{t}^{k} ( {n}_{t}^{1} , … , {n}_{t}^{R} ) ,$$

for all k=1, . . . , K. Given that the base station 100 can estimate each KPI at fine granularity (e.g., every 10 seconds), then, in practice,

$${KPI}_{t}^{k} ( {n}_{t}^{1} , … , {n}_{t}^{R} )$$

can be computed as a function (e.g., sliding window average or discounted average) of past fine-granularity KPI values as illustrated by FIG. 2. Additionally or alternatively,

$${KPI}_{t}^{k} ( {n}_{t}^{1} , … , {n}_{t}^{R} )$$

can also represent a relevant statistic of the corresponding KPI, e.g., the q-th lowest percentile of the KPI distribution. It will be appreciated that, in various embodiments, a sliding time window may be divided into a plurality of time steps including the present time step and the future time step subsequent to the present time step. In one or more embodiments, a present time step and/or a future time step subsequent to the present time step associated with the sliding time window can be defined in increments of seconds, minutes, hours, or a combination of seconds, minutes, or hours.

KPI's associated with the performance of the base station 100 are expected to exceed one or more user-defined limits y. It can be understood that OKₜ=1 if at time t each KPI exceeded its limit, and OKₜ=0 otherwise. The OKₜ may be defined according to Equation (1), such that

$${OK}_{t} := 1 ( {⋂}_{k = 1}^{K} \{ {KPI}_{t}^{k} ( {n}_{t}^{1} , … , {n}_{t}^{R} ) \geq {y}^{k} \} ) , \qquad ( 1 )$$

where 1(a)=1 if a is True and 1(a)=0 otherwise.

In some instances, OKₜ=1 can be overwritten in response to the current load on the base station 100 being less than a threshold and the KPI statistics being unreliable. When the resource configuration

$${n}_{t}^{1} , … , {n}_{t}^{R}$$

is being used, the base station 100 consumes a predefined amount of power denoted by cₜ

$$( {n}_{t}^{1} , … , {n}_{t}^{R} ) .$$

In some other instances, an increase in a number of resources used causes an increase in the power consumption of the base station 100 and/or an improvement in the KPIs. The power consumed cₜ(n¹, . . . , n^{R}) and

$${KPI}_{t}^{k}$$

(n¹, . . . , n^{R}) may increase with respect to n^{r} for all r=1, . . . , R and for each k=1, . . . , K.

O̅K̅ₜ may be indicative of a frequency at which the KPIs are acceptable over the last T^{OK} samples as illustrated in FIG. 2 and according to Equation (2), such that

$${\overline{OK}}_{t} := \frac{1}{{T}^{OK}} {\sum }_{i = 0}^{{T}^{OK} - 1} {OK}_{t - i} , ∀ t , \qquad ( 2 )$$

where O̅K̅ₜ:=OKₜ if T^{OK}=1.

In certain embodiments, the minimum acceptable frequency for which the KPIs are acceptable can be pre-defined. For example, an end user associated with the base station 100 (e.g., a mobile network operator) can define the minimum acceptable value for O̅K̅ₜ, which is denoted by x. Additionally, based upon the minimum acceptable value for O̅K̅ₜ, a KPI budget, or KPI constraint, can be determined. The KPI budget, denoted by bₜ, is defined as the difference between O̅K̅ₜ and the limit x, such that

$${b}_{t} := {\overline{OK}}_{t} - x \qquad ( 3 )$$

The KPI budget is instrumental for determining when to add, remove, and/or reconfigure one or more resources of a base station (e.g., base station 100). For example, as will be further detailed below, if the KPI budget associated with a particular base station is high, resources of the base station that contribute to power consumption (e.g., such as by one or more power amplifiers of the base station) can be removed and/or reconfigured in order to lower the power consumption of the base station. Alternatively, in various embodiments, if the KPI budget of the particular base station is low, resources of the base station can be added and/or reconfigured to ensure that one or more UEs communicating on a communications network associated with the base station will be adequately served by the base station while adhering to the one or more KPI constraints associated with the base station.

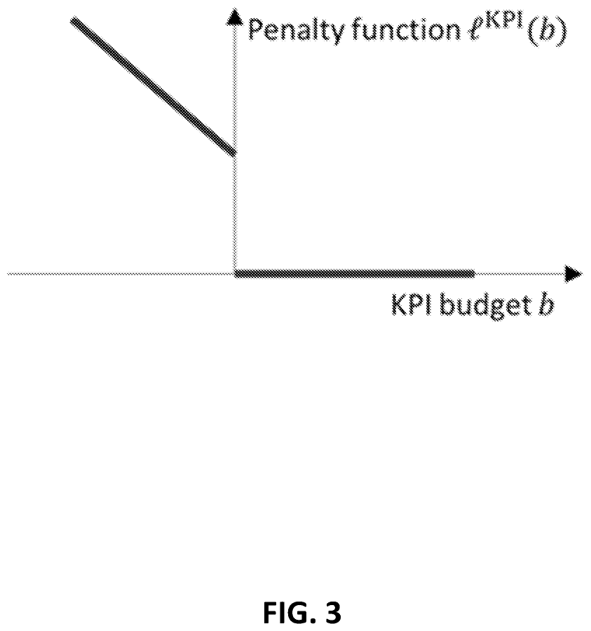

FIG. 3 illustrates a KPI budget violation penalty associated with a base station in accordance with one or more example embodiments of the present disclosure. In general, even for an oracle algorithm knowing future KPI values it would be impossible to guarantee the KPI budget bₜ to be positive at all times t. For this reason, the formulation can be relaxed, and a penalty can be imposed whenever the KPI budget bₜ is violated, e.g., the KPI budget bₜ is negative, in order to minimize the occurrence of the KPI budget bₜ being negative. To discourage the KPI budget bₜ to be negative, a non-increasing penalty function [symbol] ^{KPI}(·) is introduced, with [symbol] ^{KPI}(b)=0 for positive b≥0, [symbol] ^{KPI}(b)≥0 for negative b<0 as illustrated in FIG. 3.

In one or more embodiments, in order to reduce the potential load on the base station 100 and/or the RAN associated with the base station 100, a resource configuration switch penalty can be imposed. To avoid changing resource configurations too often, an increasing resource configuration switch penalty function [symbol] ^{switch}(wₜ) (with [symbol] ^{switch}(0)=0) is introduced to limit the number of resource configuration switches wₜ made at time t, where wₜ may be defined such that

$${w}_{t} = \frac{1}{{\sum }_{r = 1}^{R} {v}_{r}} {\sum }_{r = 1}^{R} {v}_{r} \vert {n}_{t}^{r} - {n}_{t - 1}^{r} \vert . \qquad ( 4 )$$

It can be understood that νᵣ is a weighting factor that regulates the impact of a switch of a specific resource type (for instance, muting a transmission path can be done at a lesser traffic impact than switching off of a cell, hence the corresponding νᵣ should be lower). The resource configuration switch penalty function [symbol] ^{switch}(w) can be simply defined as a linear function of w, e.g., [symbol] ^{switch}(w)=aw, with a>0.

It is therefore desirable to find the resource configuration policy

$${\{ {n}_{t}^{r} \}}_{r , t}$$

that reduces or minimizes the average sum of power consumption by the base station 100, the KPI budget violation penalty, and the resource configuration switch penalty. Such a resource configuration policy

$${\{ {n}_{t}^{r} \}}_{r , t}$$

is defined according to Equation (5), such that

$${min}_{{\{ {n}_{t}^{r} \}}_{r , t}} {lim}_{W \to ∞} \frac{1}{W} {\sum }_{t = 1}^{W} [ {c}_{t} ( {n}_{t}^{1} , … , {n}_{t}^{R} ) + {ℓ}^{KPI} ( {b}_{t} ) + {ℓ}^{switch} ( {w}_{t} ) ] \qquad ( 5 )$$

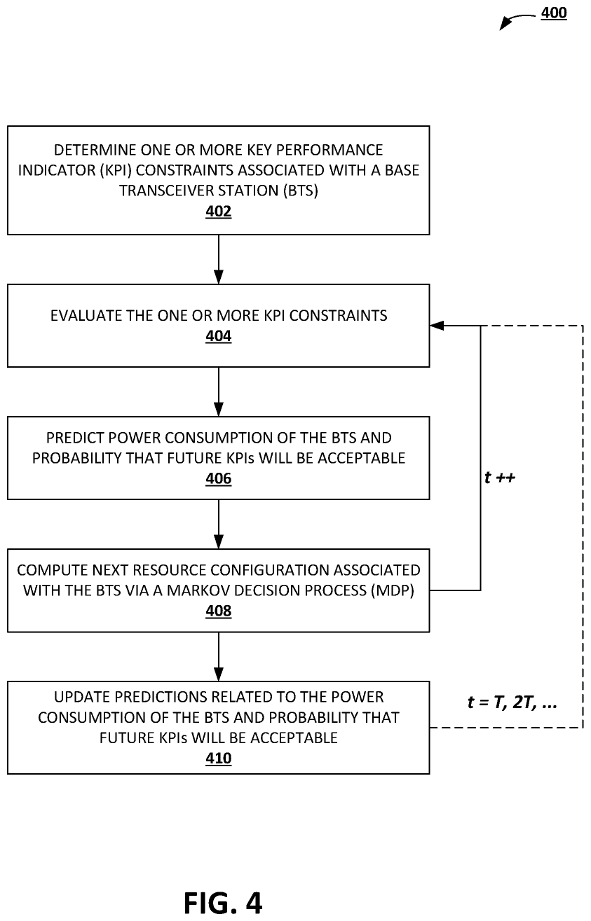

FIG. 4 illustrates a flowchart depicting a method 400 for reducing power consumption at a base station subject to user-defined KPI constraints using the MDP in accordance with one or more example embodiments of the present disclosure. The method 400 can be implemented, for example, by one or more components of an apparatus, one example of which is the base station 100 of FIG. 1. Although described herein in the context of a base station 100, other apparatuses, such as an apparatus associated with and/or in communication with the base station, may be configured to perform the method 400 with the reference to the base station 100 being provided by way of example but not of limitation. It will be appreciated that many of the operations performed by the method 400 are executed repeatedly over time and can be understood to occur on a time scale of a sliding time window as illustrated in FIG. 2. For example, the operations in block 410 can occur at a slower time scale (e.g., at time steps t=0, T, 2T, . . . where T is in the order of few tens or hundreds) relative to the operations performed in block 404 which occur at smaller time steps (e.g., t=0,1, . . . T).

As shown in block 402 of FIG. 4, the base station 100 includes means, such as the processing circuitry 104, at least one processor, at least one memory 106, and/or the like, configured to determine one or more user-defined KPI constraints associated with a base station (e.g., base station 100). For example, the one or more user-defined KPI constraints can comprise a list of KPIs to be preserved, denoted by KPI¹, . . . , KPI^{K}, a list of user defined limits y^{k} for KPI^{k}, for k=1, . . . , K, the minimum acceptable value x related to the frequency of acceptable KPI samples as they correspond to the one or more user-defined KPI constraints, and/or the length T^{OK} of the sliding time window in which the one or more KPIs associated with the base station 100 are evaluated.

In one or more embodiments, an end user associated with the base station 100 (e.g., a mobile network operator) can define one or more key performance indicators (KPIs) associated with the operating performance of the base station 100 and, as noted above, constraints may be defined for some or all of the KPIs. KPIs can include, but are not limited to, hand over success rate (HOSR), inter-RAT handover (IRAT), paging success rate (PSR), standalone dedicated control channel (SDCCH) availability rate, SDCCH congestion rate, SDCCH call drop rate, traffic channel (TCH) availability, TCH call drop rate, TCH congestion rate, TCH assignment success rate, call setup success rate (CSSR), call complete success rate (CCSR), call setup delay, and/or various KPIs associated with the various hardware components (e.g., RF (or wireless) transceiver 102A, power system 108, antenna system 112) associated with the base station 100.

As shown in block 404, the base station 100 also includes means, such as the processing circuitry 104, at least one processor, at least one memory 106, and/or the like, configured to evaluate the one or more user-defined KPI constraints. For example, at time steps t=0,1, . . . T of a sliding time window and given the current resource configuration setting

$${n}_{t}^{1} , … , {n}_{t}^{R} ,$$

the processing circuitry 104 of the base station 100 of an example embodiment can evaluate

$${KPI}_{t}^{k} ( {n}_{t}^{1} , … , {n}_{t}^{R} ) ,$$

for all k=1, . . . , K. The processing circuitry 104 also computes the binary variable OKₜ expressing whether each user-defined KPI is acceptable, e.g., whether the user-defined KPIs exceed the pre-defined limits y^{k} by calculating

$${OK}_{t} = 1 ( {⋂}_{k = 1}^{K} {\overline{KP I}}_{t}^{k} ( {n}_{t} ) \geq {y}^{k} )$$

(e.g., according to Equation (1)). The processing circuitry 104 of an example embodiment also updates the frequency at which the user-defined KPIs are acceptable (O̅K̅ₜ) such as by calculating

$${\overline{OK}}_{t} = \frac{1}{{T}^{OK}} {\sum }_{i = 0}^{{T}^{O K} - 1} {OK}_{t - i} ,$$

∀t (e.g., according to Equation (2)). It will be appreciated that in some circumstances, O̅K̅ₜ can be updated using the lightweight iterative formula O̅K̅ₜ=O̅K̅ₜ₋₁+(OKₜ−OK_{t-T}_{^{OK}}). The processing circuitry 104 of an example embodiment also computes the current KPI budget bₜ by computing bₜ:=O̅K̅ₜ−x (e.g., according to Equation (3)).

As shown in block 406, the base station 100 also includes means, such as the processing circuitry 104, at least one processor, at least one memory 106, and/or the like, configured to predict the power consumption of the base station (e.g., base station 100) and the probability that future KPIs will be acceptable. For example, the base station 100 can estimate, by way of the processing circuitry 104, the power consumption, denoted by c(n¹, . . . , n^{R}), for any possible per-type resource configuration, denoted by n¹, . . . , n^{R}, over the next one or more time step(s). Additionally, the base station 100 can estimate, by way of the processing circuitry 104, the probability that the user-defined KPIs will be within an acceptable range in the next one or more time step(s) for any possible per-type resource configuration, denoted by n¹, . . . , n^{R}, and defined using Equation (6), such that

$$p ( {n}^{1} , … , {n}^{R} ) : = Pr ( OK = 1 \vert {n}^{1} , … , {n}^{R} ) , ∀ {n}^{1} , … , {n}^{R} , {t}^{′} > t . \qquad ( 6 )$$

The processing circuitry 104 of the base station 100 can estimate the conditional probability that a particular KPI will be acceptable for a current resource configuration given the current physical resource block (PRB) utilization for a particular cell (or network coverage area) and the current radio conditions in the environment associated with the base station 100. The conditional probability is defined according to Equation (7), such that

$$Pr ( OK = 1 \vert {n}^{1} , … , {n}^{R} , {\{ {L}^{i} \}}_{i} , Ω ) , ∀ {n}^{1} , … , {n}^{R} , Ω , \qquad ( 7 )$$

where Lⁱ is indicative of the PRB utilization of cell i and Ω measures the radio conditions, e.g., Channel Quality Indicator (CQI) for each frequency layer. In one example, the PRB may be a smallest unit of radio resources that can be allocated to a UE and is composed of a set of subcarriers (e.g., orthogonal frequency division multiplexing (OFDM) subcarriers). The PRB utilization of a cell may impact an amount of power consumed by the base station 100 (e.g., by the power system 108).

To estimate the conditional probability Pr(OK=1|n¹, . . . , n^{R}, {Lⁱ}ᵢ, Q) (e.g., according to Equation (7)), the processing circuitry 104 of the base station 100 of an example embodiment collects a historical dataset comprising tuples including values of n¹, . . . , n^{R} {Lⁱ}ᵢΩ and the associated OK variable. Certain embodiments include estimating the conditional probability as defined in Equation (7) in various ways. In some embodiments, the conditional probability can be estimated using a simple tabular formation. The tabular entry n¹, . . . , n^{R}, Ω contains the average of the corresponding OK values contained in the dataset and can be looked up by the processing circuitry 104.

In various other embodiments, the conditional probability can be estimated via non-parametric density estimation techniques. For instance, Kernel Density Estimation (KDE) can be used. Similar to the tabular formation, KDE takes as input the values of n¹, . . . , n^{R}, {Lᵢ}ᵢ, Ω observed in the past along with the associated OK variable and outputs a function that estimates the conditional probability of the OK variable given n¹, . . . , n^{R}, {Lᵢ}ᵢ, Ω. Non-parametric density estimation techniques generally need smaller datasets than the tabular technique, and therefore offer the benefit of utilizing fewer computational resources (e.g., memory 106) associated with the base station 100.

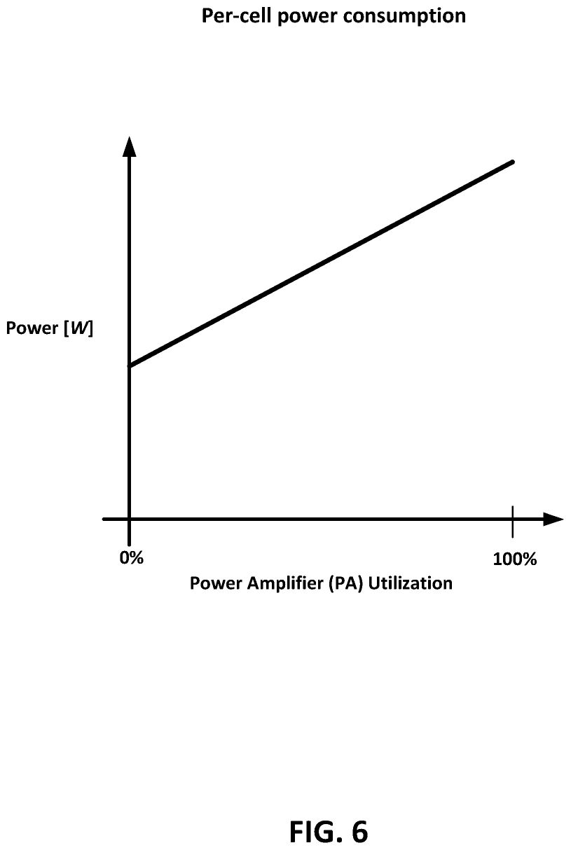

Per-cell power consumption at the base station 100 can be well approximated via an affine function of the power amplifier utilization rate, as illustrated in FIG. 6. The slope and the intercept depend on the remote radio head (RRH) associated with the base station 100 that is being powered by the power amplifier. Since each power amplifier can potentially serve multiple cells depending on the RRH configuration, there exists an affine function linking the set of PRB utilization of each cell (where Lⁱ is the PRB utilization of cell i) and the RF power consumption c. In one example, an affine function may be defined according to Equation (8), such that

$$C ( {\{ {L}^{i} \}}_{i} , {n}^{1} , … , {n}^{R} ) = {a}_{0} + {\sum }_{i} {a}_{i} {L}^{i} . \qquad ( 8 )$$

The base station 100, by way of the processing circuitry 104, can estimate parameters {aᵢ}ᵢ for such an affine relation as defined in Equation (8), such as on a periodic basis. For example, the base station 100 can periodically evaluate the PRB utilization for each cell associated with base station 100, evaluate the corresponding RF power consumption, and compute parameters {aᵢ}ᵢ via standard linear regression.

At any given time t, the processing circuitry 104 of base station 100 of an example embodiment knows the current radio conditions (e.g., CQI), denoted by Ωₜ, the current PRB utilization on each cell i, denoted by

$${\{ {L}_{t}^{i} \}}_{i} ,$$

and the current resource configuration, denoted by

$${n}_{t}^{1} , … , {n}_{t}^{R} .$$

Using this data, the processing circuitry 104 is configured to estimate whether the predicted KPIs in the next one or more time step(s) are within corresponding predefined thresholds according to Equation (9), such that

$$Pr ( {OK}_{t + 1} = 1 \vert {n}_{t + 1}^{1} = {n}^{1} , … , {n}_{t + 1}^{R} = {n}^{R} , {\{ {L}_{t + 1}^{i} \}}_{i} , {Ω}_{t + 1} ) : = p ( {n}^{1} , … , {n}^{R} ) , ∀ {n}^{1} , … , {n}^{R} . \qquad ( 9 )$$

Additionally or alternatively, the processing circuitry 104 may be configured to estimate the power consumption of the base station 100 based on any possible per-type resource configuration, according to Equation (10), such that

$$C ( {\{ {L}_{t + 1}^{i} \}}_{i} , {n}_{t + 1}^{1} = {n}^{1} , … , {n}_{t + 1}^{R} = {n}^{R} ) : = c ( {n}^{1} , … , {n}^{R} ) , ∀ {n}^{1} , … , {n}^{R} . \qquad ( 10 )$$

It will be appreciated that the processing circuitry 104 of the base station 100 may assume that channel conditions Ω are not significantly impacted by a change of configuration, e.g., that Ωₜ₊₁≈Ωₜ.

The processing circuitry 104 is configured to predict the value of the PRB utilization at the next time step, denoted by

$${L}_{t + 1}^{i} ,$$

on each active frequency layer i for each possible value of the next configuration

$${n}_{t + 1}^{1} = {n}^{1} , … , {n}_{t + 1}^{R} = {n}^{R} .$$

In this regard, a few simplifying assumptions may be made in one example embodiment. For instance, with regard to executing a cell switch-off, perfect load balancing can be assumed such that the total load in terms of used PRBs among active cells associated with the base station 100 is redistributed equally across the cells active in the next configuration. With regard to MIMO muting, as a first-order approximation, it can be assumed that if all UEs utilizing the base station 100 are transmitting in full rank, switching off a certain portion q of the transmission paths associated with the base station 100 leads to a q-fold increase of the PRB utilization on each frequency layer (e.g., with q=2, 4TX reduces to 2TX, 2TX reduces to 1TX, etc.).

As shown in block 408, the base station 100 also includes means, such as the processing circuitry 104, at least one processor, at least one memory 106, and/or the like, configured to compute the next resource configuration associated with the base station (e.g., base station 100). At each time step t=0, 1, . . . T the processing circuitry 104 of the base station 100 of an example embodiment computes a resource configuration strategy, such as the optimal resource configuration strategy, to be followed over next one or more time step(s). For example, the processing circuitry 104 can compute and implement the next resource configuration, denoted by

$${n}_{t + 1}^{1} , … , {n}_{t + 1}^{R} ,$$

by solving a corresponding MDP.

The MDP may include states, actions, transition probabilities (also known as state transitions), and rewards/costs. The policy (or strategy) of an MDP determines a desired, e.g., optimal, action for the system to execute given a current state such that the system can gain an enhanced or maximum reward (or incur a reduced or minimum cost). The MDP formulation employed by the certain embodiments of the present disclosure can be defined as follows.

The state sⱼ at step j is defined as the collection of

$${\#}_{j} = {\sum }_{i = 0}^{{T}^{O K} - 1} {OK}_{j - i} ,$$

e.g., the number of OK variables equal to 1 in the sliding window. In this regard, it is noted that the KPI budget can be derived as

$${b}_{j} = \frac{{\#}_{j}}{{T}^{OK}} - x )$$

and the current set of per-type resource configuration indexes is defined as

$$[ {n}_{j}^{1} , … , {n}_{j}^{R} ] .$$

The action aⱼ can be defined as the per-type resource configuration index increment

$$[ {n}_{j + 1}^{1} - {n}_{j}^{1} , … , {n}_{j + 1}^{R} - {n}_{j}^{R} ]$$

in the next step j+1. To avoid abrupt resource configuration changes, the processing circuitry 104 of an example embodiment can execute computer program instructions that impose rules that at most a predefined number, such as one, resource index is modified by at most a predefined number of units, such as one unit. In this case, the action is aⱼ=±e^{r} where

$${e}_{r}^{r} = 1 and {e}_{r}^{r} = 0$$

otherwise.

The strategy (also known as a policy) π defines the action π(s)=a to be taken in each state s.

The cost incurred by taking action a in state sⱼ may be defined as the sum of predicted power consumption of the base station 100 for the next resource configuration, denoted by

$$c ( {n}_{j + 1}^{1} , … , {n}_{j + 1}^{R} ) ,$$

the KPI budget violation penalty function, denoted by [symbol] ^{KPI}(bⱼ₊₁), and the resource configuration switch penalty, denoted by [symbol] ^{switch}(wⱼ₊₁), as defined in Equation (11).

$$h ( {s}_{j} , a , {s}_{j + 1} ) := c ( {n}_{j + 1}^{1} , … , {n}_{j + 1}^{R} ) + {ℓ}^{K P I} ( {b}_{j + 1} ) + {ℓ}^{s w i t c h} ( {w}_{j + 1} ) . \qquad ( 11 )$$

The state transitions (also known as the transition probabilities) can be defined according to Equation (12) such that the probability of transitioning from #ⱼ to #ⱼ₊₁=#ⱼ+1 is the joint probability that OK_{j-T}_{^{OK}}₊₁=0 (given that current KPI budget is bⱼ) and OKⱼ₊₁=1.

$$Pr ( {\#}_{j + 1} = {\#}_{j} + 1 ) ( 1 - \frac{{\#}_{j}}{{T}^{OK}} ) p ( {n}_{j + 1}^{1} , … , {n}_{j + 1}^{R} ) \qquad ( 12 )$$

The probability of transitioning from #ⱼ to #ⱼ₊₁=#ⱼ−1 is the joint probability that OK_{j-T}_{^{OK}}₊₁=1 (given that current budget is bⱼ) and OKⱼ₊₁=0, defined according to Equation (13), such that

$$Pr ( {\#}_{j + 1} = {\#}_{j} - 1 ) = \frac{{\#}_{j}}{{T}^{OK}} ( 1 - p ( {n}_{j + 1}^{1} , … , {n}_{j + 1}^{R} ) ) . \qquad ( 13 )$$

The probability of transitioning from #ⱼ to #ⱼ₊₁=#ⱼ is the sum of joint probability that OK_{j-T}_{^{OK}}₊₁=0 (given that current budget is bⱼ) and OKⱼ₊₁=0 and that OK_{j-T}_{^{OK}}₊₁=1 and OKⱼ₊₁=1, defined according to Equation (14), such that

$$Pr ( {\#}_{j + 1} = {\#}_{j} ) = \frac{{\#}_{j}}{{T}^{OK}} p ( {n}_{j + 1}^{1} , … , {n}_{j + 1}^{R} ) + ( 1 - \frac{{\#}_{j}}{{T}^{OK}} ) ( 1 - ( {n}_{j + 1}^{1} , … , {n}_{j + 1}^{R} ) ) . \qquad ( 14 )$$

The optimal resource configuration strategy π* is defined according to Equation (15), such that

$${π}^{*} = arg {min}_{π} {\sum }_{j = 1}^{∞} {β}^{j} [ h ( {s}_{j} , {a}_{j} , {s}_{j + 1} ) ] , \qquad ( 15 )$$

where β∈(0,1) is the discount factor that adds bounds to the optimal resource configuration strategy and/or augments the performance of the base station 100 based on one or more penalties and rewards (e.g., penalties for switching resource configurations and/or violating KPI budgets).

To compute π*, the processing circuitry 104 of the base station 100 of an example embodiment can use MDP solvers such as policy iteration or value iteration.

In order to increase the performance of the base station 100 as well as reduce the computational load on the various components of the base station 100 (e.g., the processing circuitry 104 and memory 106), the state space (e.g., the number of possible states) has a limited size which makes computations (to be performed once every few minutes) lightweight. For example, the number of possible states comprised within the state space can be in the order of few hundreds, if, for example, T^{OK}≈50, R≈2, N^{r}≈3.

It will be appreciated that different resource types associated with the base station 100 have different (de-)activation latency values. For instance, a transmission path can be switched off much faster than a frequency layer which requires a graceful shutdown. To incorporate this in the MDP model, an example embodiment can augment the MDP state with a counter that keeps track of the number of time steps t elapsed since the action to change resource r was chosen. In such embodiments, prior to the counter reaching a predefined value A^{r} (e.g., a value corresponding to the typical (de-)activation time for resource r), the resource configuration remains static at a predefined value (e.g., at a previously chosen/selected value).

In various embodiments, one or more power amplifiers of the power system 108 associated with the base station 100 can be put to sleep at different depth levels. There is a trade-off between sleep depth and power consumption (the deeper the sleep, the smaller the power consumption) and sleep depth and the re-activation delay (the deeper the sleep, the slower the re-activation of a resource). This can be incorporated into the MDP in a manner similar to the one described in reference to (de-)activation latency of difference resource types. For example, an example embodiment can augment the MDP state with a counter that keeps track of the number of time steps t elapsed since the action to re-activate the one or more power amplifiers of the power system 108 that was sleeping at a respective sleep depth level. In an example embodiment, the counter can have a predefined upper limit value that depends on the respective sleep depth of the power amplifiers. In such embodiments, prior to the counter reaching a predefined value (e.g., a value corresponding to the typical (re-)activation time for the one or more power amplifiers), the resource configuration remains static at a predefined value (e.g., at a previously chosen/selected value).

As shown in block 410, the base station 100 also includes means, such as the processing circuitry 104, at least one processor, at least one memory 106, and/or the like, configured to update the predicted power consumption of the base station (e.g., base station 100) and/or the predicted probability that future KPIs associated with the base station will be acceptable. For example, based on new KPI evaluations, the base station 100, by way of the processing circuitry 104, updates the models producing predictions p, c (as computed by the operation in block 406). The operations in block 410 occur at a slower time scale (e.g., at time steps t=0, T, 2T, . . . where T may be on the order of few tens or hundreds) relative to the operations performed in block 404 which occur at smaller time steps (e.g., t=0,1, . . . T), as illustrated in FIG. 4. The method 400 then repeats by returning to block 404 such that the operations described above are executed based on the updated predictions and the power consumption of the base station 100 (e.g., consumed by power system 108) can be repeatedly evaluated and reduced.

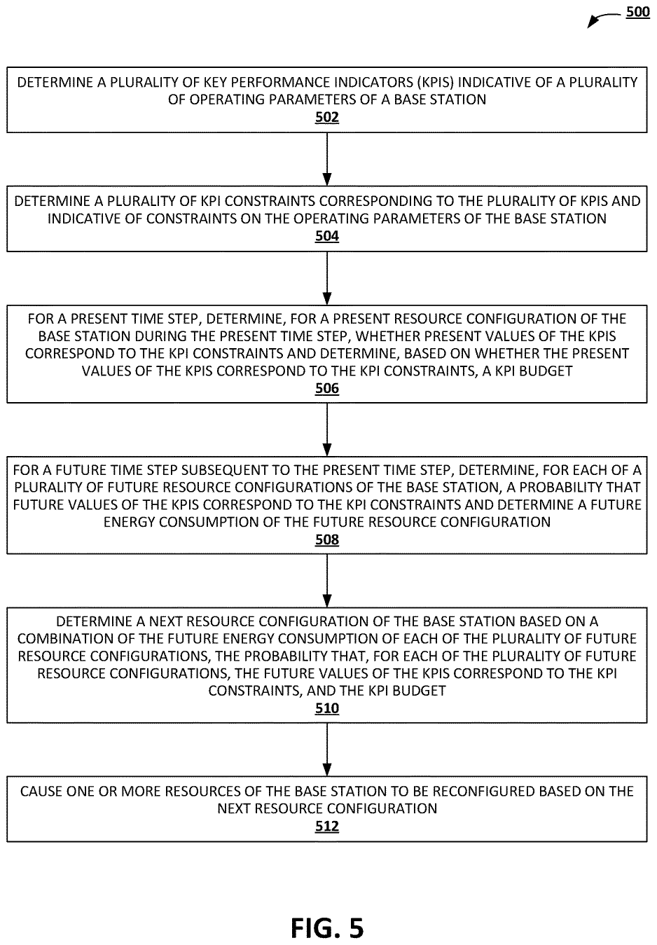

FIG. 5 illustrates another flowchart depicting a method for reducing power consumption at a base station subject to KPI constraints via an MDP in accordance with one or more example embodiments of the present disclosure. The method 500 can be implemented, for example, by one or more components of an apparatus, such as the base station 100 of FIG. 1. Although described herein in the context of a base station 100, other apparatuses, such as an apparatus associated with and/or in communication with the base station, may be configured to perform the method 500 with the reference to the base station 100 again being provided by way of example but not of limitation. It will be appreciated that many of the operations performed by the method 500 are executed repeatedly over time and can be understood to occur on a time scale as illustrated in FIG. 2.

As shown in block 502 of FIG. 5, an apparatus embodied by the base station 100 includes means, such as the processing circuitry 104, at least one processor, at least one memory 106, and/or the like, configured to determine a plurality of key performance indicators (KPIs) indicative of a plurality of operating parameters of a base station. In one or more embodiments, an end user associated with the base station 100 (e.g., a mobile network operator) can define one or more key performance indicators (KPIs) associated with the operating performance of the base station 100. KPIs can include, but are not limited to, hand over success rate (HOSR), inter-RAT handover (IRAT), paging success rate (PSR), standalone dedicated control channel (SDCCH) availability rate, SDCCH congestion rate, SDCCH call drop rate, traffic channel (TCH) availability, TCH call drop rate, TCH congestion rate, TCH assignment success rate, call setup success rate (CSSR), call complete success rate (CCSR), call setup delay, and/or various KPIs associated with the various hardware components (e.g., RF (or wireless) transceiver 102A, power system 108, antenna system 112) associated with the base station 100.

As shown in block 504 of FIG. 5, the apparatus embodied by the base station 100 includes means, such as the processing circuitry 104, at least one processor, at least one memory 106, and/or the like, configured to determine a plurality of KPI constraints corresponding to the plurality of KPIs and indicative of constraints on the operating parameters of the base station. For example, the one or more user-defined KPI constraints can comprise a list of KPIs to be preserved, denoted by KPI¹, . . . , KPI^{K}, a list of user defined limits y^{k} for KPI^{k}, for k=1, . . . , K, the minimum acceptable value x related to the frequency of acceptable KPI samples as they correspond to the one or more user-defined KPI constraints, and/or the length T^{OK} of the sliding time window in which the one or more KPIs associated with the base station 100 are evaluated.

As shown in block 506 of FIG. 5, the apparatus embodied by the base station 100 includes means, such as the processing circuitry 104, at least one processor, at least one memory 106, and/or the like, configured to, for a present time step, determine, for a present resource configuration of the base station during the present time step, whether present values of the KPIs correspond to the KPI constraints and determine, based on whether the present values of the KPIs correspond to the KPI constraints, a KPI budget. There can be various resource “types” associated with the base station 100 that can be indexed, and there can exist R different resource types indexed by r=1, . . . , R. Each resource type r=1, . . . , R can be in a different configuration state, indexed by n^{r}=1, . . . , N^{r}, where N^{r} is the number of available configurations for resource r. Index n^{r} is meant to be increasing with the number of active resources of type r (hence, n^{r} is not necessarily the number of active resources). The base station 100 can determine, for a present time step, a current resource configuration associated with the various resources related to the base station 100. As a non-limiting example, the processing circuitry 104 can determine how many cells associated with respective radio frequencies are being served by a particular base station 100. As another non-limiting example, the processing circuitry 104 can determine how many radiating elements are active for a particular antenna array (e.g., an antenna array associated with antenna system 112) associated with the base station 100.

Furthermore, the apparatus embodied by the base station 100 can, by way of the processing circuitry 104, determine whether the present values of the user-defined KPIs correspond to the one or more user-defined KPI constraints of the base station 100. For example, at time steps t=0,1, . . . T of a sliding time window and given the current resource configuration setting

$${n}_{t}^{1} , … , {n}_{t}^{R} ,$$

the processing circuitry 104 of the base station 100 of an example embodiment can evaluate

$$K P {I}_{t}^{k} ( {n}_{t}^{1} , … , {n}_{t}^{R} )$$

for all k=1, . . . , K. The processing circuitry 104 also computes the binary variable OKₜ expressing whether each user-defined KPI is acceptable, e.g., whether the user-defined KPIs exceed the pre-defined limits y^{k} by calculating

$${OK}_{t} = 1 ( {∩}_{k = 1}^{K} {\overline{KPI}}_{t}^{k} ( {n}_{t} ) \geq {y}^{k} )$$

(e.g., according to Equation (1)). The processing circuitry 104 of an example embodiment also updates the frequency at which the user-defined KPIs are acceptable (O̅K̅ₜ) such as by calculating

$${\overline{OK}}_{t} = \frac{1}{{T}^{OK}} {\sum }_{i = 0}^{{T}^{O K} - 1} {OK}_{t - i} ,$$

∀t (e.g., according to Equation (2)). It will be appreciated that in some circumstances, O̅K̅ₜ can be updated using the lightweight iterative formula O̅K̅ₜ=O̅K̅ₜ₋₁+(OKₜ−OK_{t-T}_{^{OK}}).

Further still, based on whether the present values of the KPIs correspond to the KPI restraints, the processing circuitry 104 of an example embodiment can, for a present time step, determine a KPI budget bₜ by computing bₜ:=O̅K̅ₜ−x (e.g., according to Equation (3)). In one or more embodiments, determining the KPI budget includes determining a difference between the frequency of the correspondence between the present value of the KPIs and the KPI constraints and the minimum acceptable frequency of the correspondence between the present values of the KPIs and the KPI constraints. The KPI budget is instrumental for determining when to add, remove, and/or reconfigure one or more resources of the base station 100. For instance, if the KPI budget associated with a particular base station at a present time step is high, resources of the base station that contribute to power consumption (e.g., such as by one or more power amplifiers of the base station) can be removed and/or reconfigured in order to lower the power consumption of the base station. Alternatively, if the KPI budget of the particular base station at a present time step is low, resources of the base station can be added and/or reconfigured to ensure that one or more UEs communicating on a communications network associated with the base station will be adequately served by the base station while adhering to the one or more KPI constraints associated with the base station.

As shown in block 508 of FIG. 5, the apparatus embodied by the base station 100 includes means, such as the processing circuitry 104, at least one processor, at least one memory 106, and/or the like, configured to, for a future time step subsequent to the present time step, determine, for each of a plurality of future resource configurations of the base station, a probability that future values of the KPIs correspond to the KPI constraints and determine a future energy consumption of the future resource configuration. For example, the base station 100 can determine, by way of the processing circuitry 104, the probability that the user-defined KPIs will be within an acceptable range for one or more future time step(s) subsequent to a present time step for any possible per-type resource configuration, denoted by n¹, . . . , n^{R}, and defined according to Equation (6). Furthermore, the base station 100 can determine, by way of the processing circuitry 104, the future energy consumption, denoted by c(n¹, . . . , n^{R}), for any possible per-type resource configuration, denoted by n¹, . . . , n^{R}, over the one or more future time step(s) subsequent to the present time step. Additionally, in one or more embodiments, determining, for each of the plurality of future resource configurations, the probability that future values of the KPIs correspond to the KPI constraints is based in part on the present resource configuration, a plurality of present radio conditions, and a present network load.

As shown in block 510 of FIG. 5, the apparatus embodied by the base station 100 includes means, such as the processing circuitry 104, at least one processor, at least one memory 106, and/or the like, configured to determine a next resource configuration of the base station based on a combination of the future energy consumption of each of the plurality of future resource configurations, the probability that, for each of the plurality of future resource configurations, the future values of the KPIs correspond to the KPI constraints, and the KPI budget.

For instance, at each time step t=0, 1, . . . T the processing circuitry 104 of the base station 100 of an example embodiment can compute a resource configuration strategy, such as the optimal resource configuration strategy π*, to be followed over one or more future time step(s). For example, the processing circuitry 104 can compute and implement the next resource configuration, denoted by

$${n}_{t + 1}^{1} , … , {n}_{t + 1}^{R} ,$$

by solving a long-term stochastic problem modeled as an MDP that minimizes an objective function in the long-term, where the objective function is a linear combination of energy consumption at a base station and a penalty for KPI budget violation. To compute π*, the processing circuitry 104 of the base station 100 of an example embodiment can use MDP solvers such as policy iteration or value iteration, the details of which are well understood and therefore not pertinent to the description of the present disclosure.

Furthermore, in one or more embodiments, determining the next resource configuration is based in part on a resource configuration switch penalty that limits switching of the present resource configuration to the next resource configuration. Additionally or alternatively, in one or more embodiments, the next resource configuration is determined based on the combination of the future energy consumption, the penalty for violation of the KPI budget and the resource configuration switch penalty. In order to increase the performance of the base station 100 as well as reduce the computational load on the various components of the base station 100 (e.g., the processing circuitry 104 and memory 106) the state space (e.g., the number of possible states) has a limited size which makes computations (to be performed once every few minutes) lightweight. For example, the number of possible states comprised within the state space can be in the order of few hundreds, if, for example, T^{OK}≈50, R≈2, N^{r}≈3.

As shown in block 512 of FIG. 5, the apparatus embodied by the base station 100 includes means, such as the processing circuitry 104, at least one processor, at least one memory 106, and/or the like, configured to cause one or more resources of the base station to be reconfigured based on the next resource configuration. For example, based on the next resource configuration computed by employing the MDP, the processing circuitry 104 can cause one or more resources associated with the base station 100 to be reconfigured.

As a non-limiting example, the processing circuitry 104 can cause one or more power amplifiers associated with the power system 108 to alter a current power output associated with the power amplifiers, thereby reducing the output of one or more associated radiating elements comprised in the antenna system 112. As another non-limiting example, based on the next resource configuration computed by employing the MDP, the processing circuitry 104 can cause one or more RF (or wireless) transceivers 102A-N to deactivate one or more respective cells associated with the base station 100, thereby reducing the power consumption of the base station 100. As another non-limiting example, based on the next resource configuration computed by employing the MDP, the processing circuitry 104 can cause the activation or deactivation of one or more frequency bands utilized by the base station 100 to facilitate the communication of one or more UEs on an associated communications network. As yet another non-limiting example, based on the next resource configuration computed by employing the MDP, the processing circuitry 104 can cause the activation or deactivation of one or more radiating elements of an antenna system (e.g., antenna system 112) of the base station 100.

Operational results of certain embodiments of the present disclosure have been benchmarked against a simple but natural greedy policy that increments the index of one resource type whenever the KPI budget is negative or respectively decrements the index of one resource type whenever the KPI budget is positive. A KPI evaluation window T^{OK}=100 and a minimum portion of acceptable KPI samples x=90% was used. The MDP policy of the various embodiments was employed using different resource configuration switch penalty functions (either no penalty, or with a penalty equal to ten (10) if there was least one configuration change).

As illustrated in FIGS. 6-16 and in Table 1, it can be appreciated that power consumption by the base station (e.g. base station 100) is minimized by the MDP policy, but not at the expense of the user-defined KPI constraints. In response to two resources of the base station having been reconfigured (e.g., optimizing operation of the base station using both cell switch-off and MIMO muting), the MDP policy is able to beat the baseline greedy policy both in terms of KPI constraint acceptability and power consumption. Additionally, the MDP policy manages to keep the KPI budget positive for the majority of the time. This means that KPIs are acceptable for a portion of at least x over sliding time windows of length T^{OK}, as defined by the user (e.g., a mobile network operator).

As illustrated and described in reference to Table 1, the baseline greedy policy under-performs in terms of KPIs compliance (only about 63% and about 57% of sliding windows satisfy the constraint of x acceptable KPI samples). Depending on the resource configuration switch penalty, the MDP policy switch frequency can be highly reduced (up to less than 1%, e.g., resource configuration is modified only 1% of the time).

TABLE 1

| | | # Resource | Compliant | Power | Switch |
|---|---|---|---|---|---|
| | Policy | types | KPI | consumption | frequency |
| 1. | Greedy | 1 | 63.72% | 2.09 | 10.99% |
| 2. | MDP (pen. 0) | 1 | 100% | 2.28 | 8.70% |
| 3. | MDP (pen. 10) | 1 | 100% | 2.54 | 0.44% |
| 4. | Greedy | 2 | 56.60% | 3.21 | 17.03% |
| 5. | MDP (pen. 0) | 2 | 99.16% | 2.84 | 16.82% |
| 6. | MDP (pen. 10) | 2 | 99.70% | 3.02 | 6.70% |

FIGS. 6-11 correspond to rows 1-3 of Table 1 and illustrate the user-defined KPI compliance and power consumption reduction of a base station (e.g., base station 100) when one resource type associated with the base station is reconfigured such as, for example, reconfiguring the base station to switch off (or switch on) one or more service cells associated with the base station.

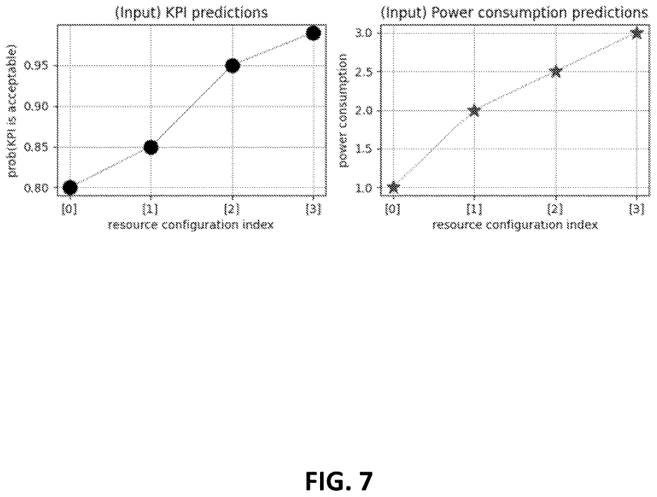

FIG. 7 illustrates example predicted values associated with the KPI compliance and power consumption of a base station (e.g., base station 100) determined, for example, using Equation (9) and Equation (10), in block 406 of the method 400. FIG. 7 illustrates example predicted values as related to the base station when one (1) resource type (R=1) associated with the base station is reconfigured and/or added. As shown, when resources are added (indicated by the resource configuration indices of the respective graphs), both the KPI compliance and power consumption of the base station increase.

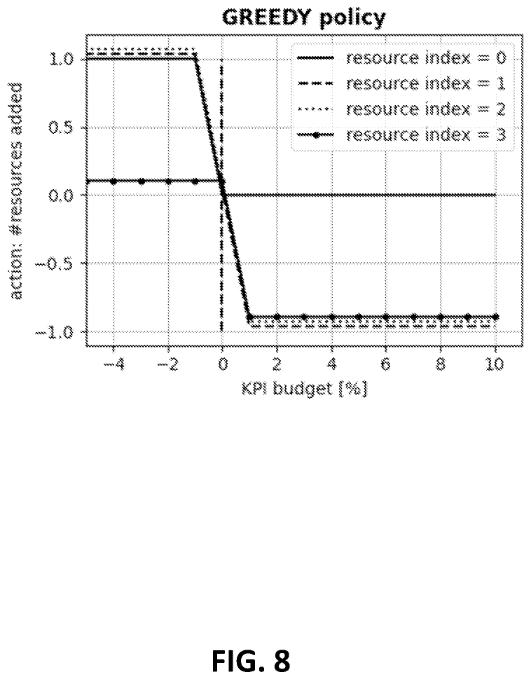

FIG. 8 illustrates an example structure of the baseline greedy policy associated with a base station (e.g., base station 100) used to compare the results of applying various embodiments of the present disclosure. As shown in FIG. 7, the baseline greedy policy is one in which one resource associated with the base station is added when the KPI budget is negative, and one resource associated with the base station is removed when the KPI budget is positive.

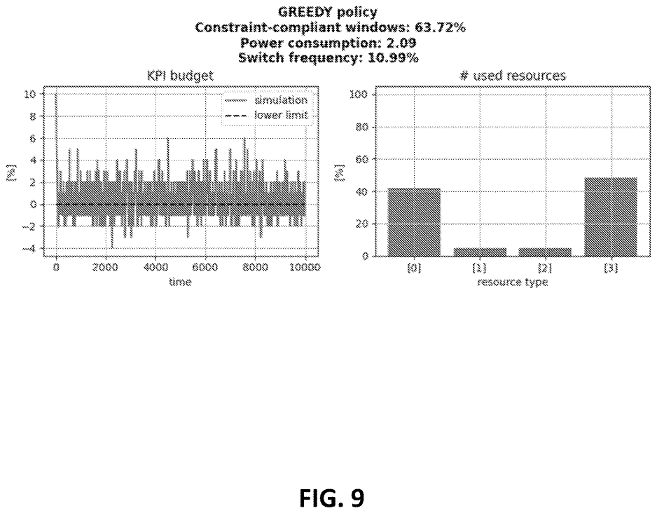

FIG. 9 illustrates an example performance of a baseline greedy policy considering one resource type (R=1) applied to a base station (e.g., base station 100) over time and generated with the predicted KPI compliance probabilities (e.g., using Equation (9)). As shown, the baseline greedy policy under-performs in terms of KPIs compliance and only 63.72% of sliding time windows of length T^{OK} satisfy the constraint of x acceptable KPI samples. Furthermore, applying the greedy policy results in a resource configuration switch frequency of 10.99%.

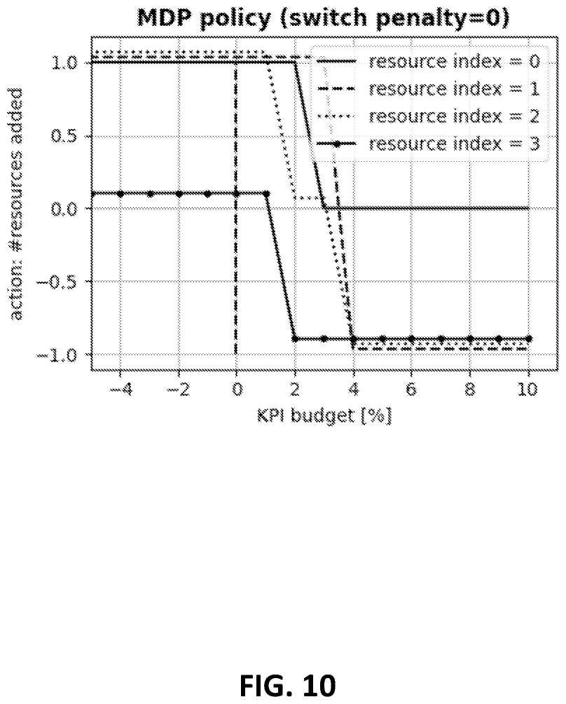

FIG. 10 illustrates an example structure of an MDP policy considering one resource type (R=1) associated with a base station (e.g., base station 100) and in which there is no resource configuration switch penalty function imposed (e.g., [symbol] ^{switch}(wₜ)=0 for w>0) to reduce the number of resource configuration switches associated with the base station.

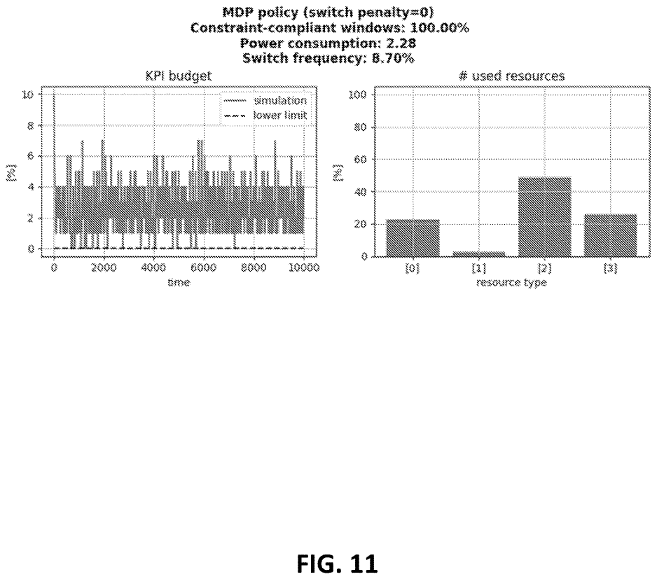

FIG. 11 illustrates an example performance of an MDP policy considering one resource type (R=1) associated with a base station (e.g., base station 100) in which there is no resource configuration switch penalty function imposed (e.g., [symbol] ^{switch}(wₜ)=0 for w>0) to reduce the number of resource configuration switches associated with the base station. With such an MDP policy, the KPI compliance is 100% and the resource configuration switch frequency is 8.70% as compared to greedy policy in which the KPI compliance was 63.72% and the resource configuration switch frequency was 10.99%.

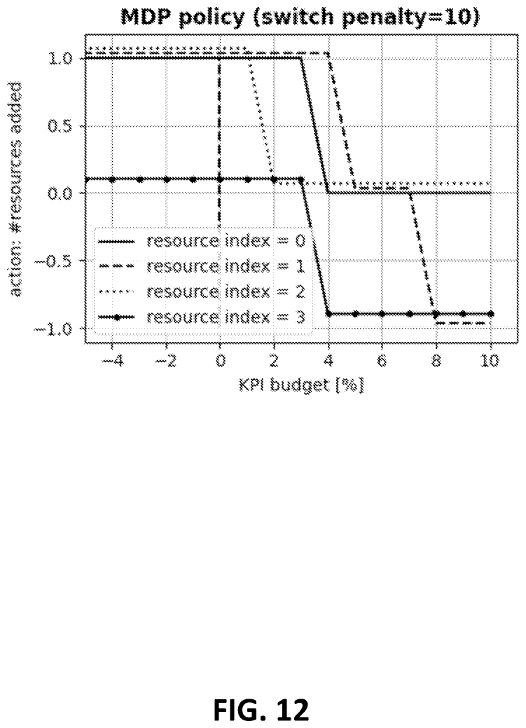

FIG. 12 illustrates an example structure of an MDP policy considering one resource type (R=1) associated with a base station (e.g., base station 100) in which there is a resource configuration switch penalty function imposed ( [symbol] ^{switch}(wₜ)=10 for w>0) to reduce the number of resource configuration switches associated with the base station. As shown, the structure of the MDP policy imposing the resource configuration switch penalty illustrates an inherent hysteresis effect (a lag between input and output in a system) that allows for a low resource reconfiguration frequency, thereby reducing the load on the communications network associated with the base station.

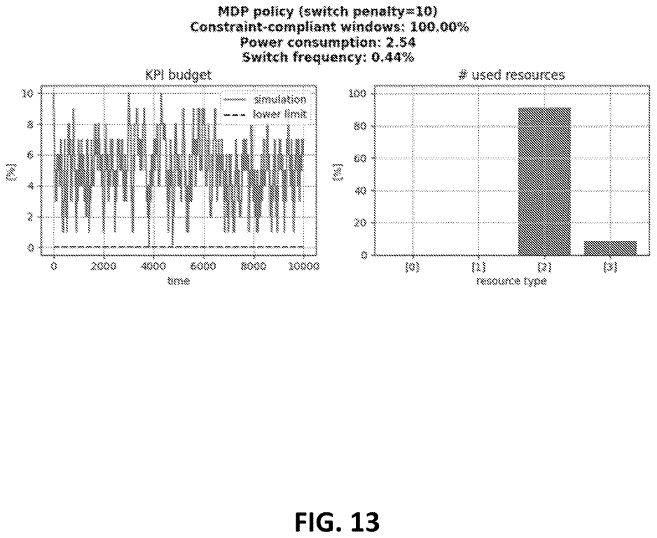

FIG. 13 illustrates an example performance of an MDP policy considering one resource type (R=1) associated with a base station (e.g., base station 100) in which there is a resource configuration switch penalty function imposed ( [symbol] ^{switch}(wₜ)=10 for w>0) to reduce the number of resource configuration switches associated with the base station. With such an MDP policy, the KPI compliance is 100% and the resource configuration switch frequency is 0.44% as compared to the greedy policy in which the KPI compliance was 63.72% and the resource configuration switch frequency was 10.99%. As shown, the power consumption of the base station is minimized by the MDP policy imposing a resource configuration switch penalty, but not at the expense of the user-defined KPI constraints.

FIGS. 13-16 correspond to rows 4-6 of Table 1 provided above and detail the user-defined KPI compliance and power consumption reduction of a base station (e.g., base station 100) when two resource types (R=2) associated with the base station are reconfigured such as, for example, reconfiguring the base station to switch off (or switch on) one or more service cells associated with the base station as well as applying MIMO muting techniques to alter an active antenna array associated with the base station.

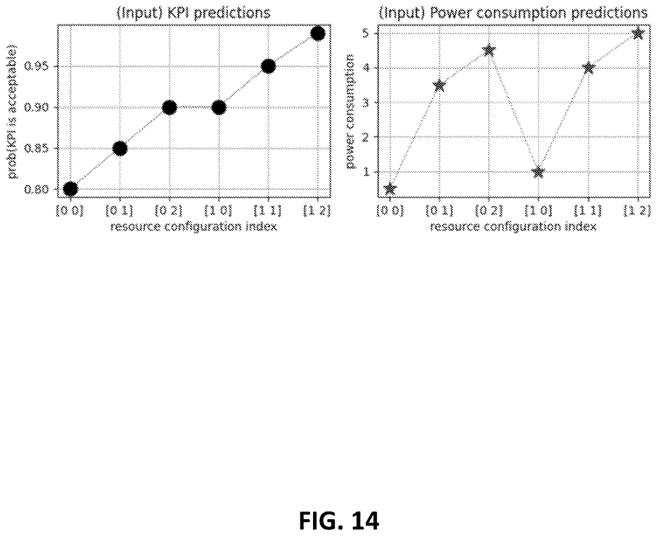

FIG. 14 illustrates example predicted values associated with the KPI compliance and power consumption of a base station (e.g., base station 100), (e.g., calculated using Equation (9) and Equation (10) according to block 406 of the method 400). FIG. 14 illustrates example predicted values related to the base station when two resource types (R=2) associated with the base station are reconfigured and/or added. As resources are added (indicated by the resource configuration indices of the respective graphs), the KPI compliance of the base station increases.

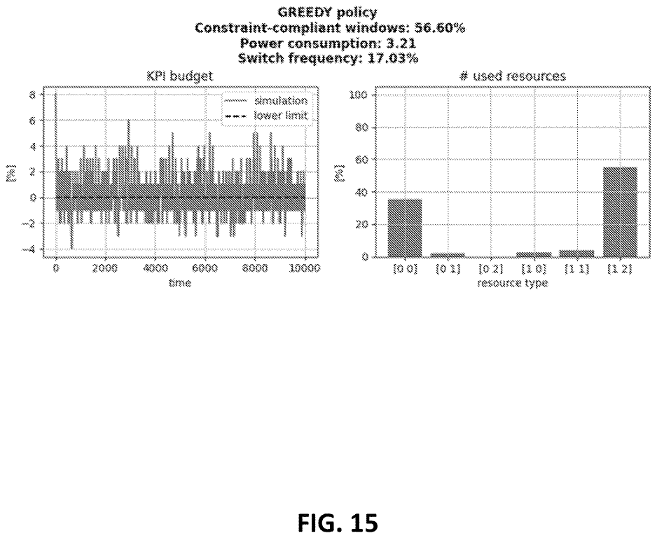

FIG. 15 illustrates an example performance of a baseline greedy policy considering two resource types (R=2) as applied to a base station (e.g. base station 100) over time and generated with the predicted KPI compliance probabilities using Equation (9). As shown, the baseline greedy policy under-performs in terms of KPIs compliance and only 56.60% of sliding time windows of length T^{OK} satisfy the constraint of x acceptable KPI samples. Furthermore, applying the greedy policy results in a resource configuration switch frequency of 17.03%.

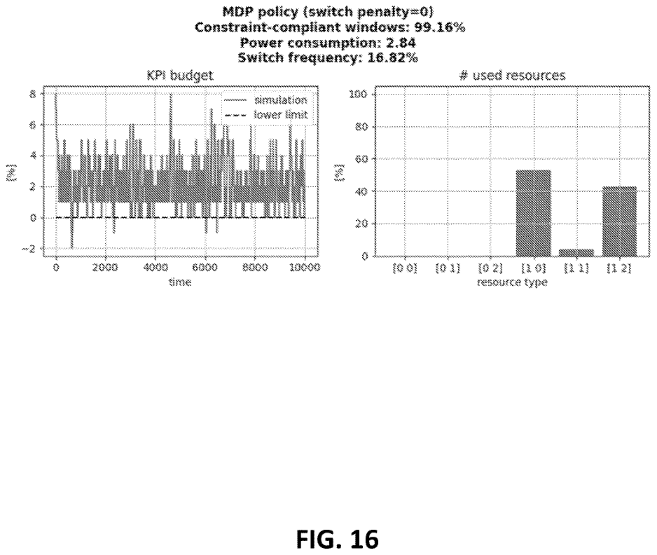

FIG. 16 illustrates the performance of an MDP policy considering two resource types (R=2) associated with a base station (e.g., base station 100) and in which there is no resource configuration switch penalty function imposed (e.g., [symbol] ^{switch}(wₜ)=0 for w>0) to reduce the number of resource configuration switches associated with the base station. With such an MDP policy, the KPI compliance is 99.16% and the resource configuration switch frequency is 16.82% as compared to the greedy policy in which the KPI compliance was 56.60% and the resource configuration switch frequency was 17.03%. Furthermore, the MDP policy outperforms the greedy policy in terms of power consumption at the base station with a power consumption of 2.84 versus a power consumption of 3.21 by applying the greedy policy.

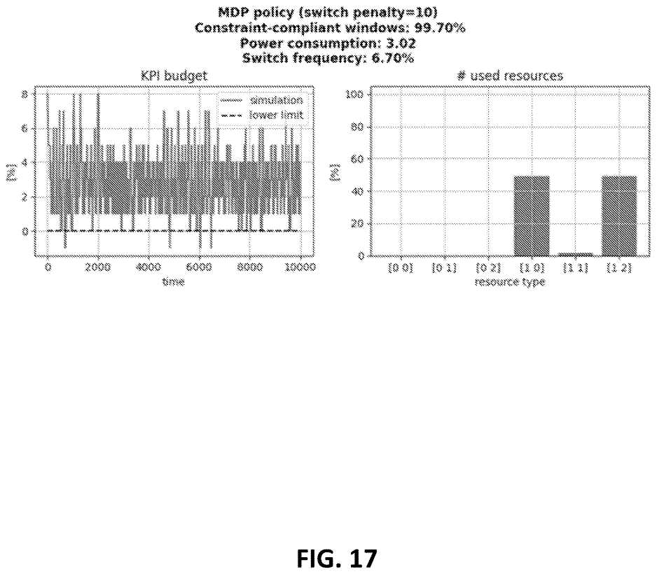

FIG. 17 illustrates the performance of an MDP policy considering two resource types (R=2) associated with a base station (e.g., base station 100) and in which there is a resource configuration switch penalty function imposed ( [symbol] ^{switch}(wₜ)=10 for w>0) to reduce the number of resource configuration switches associated with the base station. With such an MDP policy, the KPI compliance is 99.70% and the resource configuration switch frequency is 6.70% as compared to the greedy policy in which the KPI compliance was 56.60% and the resource configuration switch frequency was 17.03%. Furthermore, the MDP policy outperforms the greedy policy in terms of power consumption at the base station with a power consumption of 3.02 versus a power consumption of 3.21 by applying the greedy policy. As shown, the power consumption of the base station is minimized by the MDP policy imposing a resource configuration switch penalty, but not at the expense of the user-defined KPI constraints.

As described by FIGS. 6-16 and Table 1, an example embodiment of the present disclosure is able to jointly optimize the activation of different resource type (e.g., frequency in 4G/5G and/or transmission paths) to minimize and/or reduce power consumption at a base station (e.g., base station 100) while adhering to various user-defined KPI constraints. An example embodiment allows the customer to pre-define KPI limits that must be respected; in other words, energy is saved but not at the expense of excessive communications network traffic performance loss. Additionally, an example embodiment is able to limit the frequency of resource configuration switching to limit impact on the communications network. Furthermore, by employing optimal MDP policies, an example embodiment is robust to prediction inaccuracies since the MDP policy always prescribes to increase the number of resources in case the KPI budget is negative. Further still, an example embodiment does not depend on any critical configuration parameters that need to be tailored to each base station site and/or time of the day, and, therefore, the example embodiment does not require any (typically complex and expensive) over-the-top optimization such as would be the case, for example, for a implementing a self-organizing network (SON).

It should be appreciated that the embodiments described herein are not restricted to the system that is given as an example, such as a 5G system, and that a person skilled in the art may apply the solution to other communication systems. Additionally, although described herein in the context of a base station performing, the method, the method may be performed by other types of apparatus, such as an apparatus associated with and/or in communication with a base station, in accordance with other example embodiments.

Furthermore, implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

A computer program, such as the computer program(s) described herein, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

It will be understood that each block of the flowchart(s) and combination of blocks in the flowchart(s) can be implemented by various means, such as hardware, firmware, processor, circuitry, and/or other communication devices associated with execution of software including one or more computer program instructions. For example, one or more of the procedures described herein can be embodied by computer program instructions. In this regard, the computer program instructions which embody the procedures described herein can be stored, for example, by the memory 106 of the base station 100 or other apparatus employing an embodiment of the present disclosure and executed by the processing circuitry 104. As will be appreciated, any such computer program instructions can be loaded onto a computer or other programmable apparatus (for example, hardware) to produce a machine, such that the resulting computer or other programmable apparatus implements the functions specified in the blocks of the flowchart(s). These computer program instructions can also be stored in a computer-readable memory that can direct a computer or other programmable apparatus to function in a particular manner, such that the instructions stored in the computer-readable memory produce an article of manufacture the execution of which implements the function specified in the blocks of the flowchart(s). The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the blocks of the flowchart(s).

Accordingly, blocks of the flowchart(s) support combinations of means for performing the specified functions and combinations of operations for performing the specified functions for performing the specified functions. It will also be understood that one or more blocks of the flowchart(s), and combinations of blocks in the flowchart(s), can be implemented by special purpose hardware-based computer systems which perform the specified functions, or combinations of special purpose hardware and computer instructions.

In some embodiments, certain ones of the operations described herein may be modified or further amplified. Furthermore, in some embodiments, additional optional operations may be included. Modifications, additions, or amplifications to the operations described herein may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method comprising:
determining a plurality of key performance indicators (KPIs) indicative of a plurality of operating parameters of a base station;
determining a plurality of KPI constraints corresponding to the plurality of KPIs and indicative of constraints on the plurality of operating parameters of the base station;
for a present time step:
determining, for a present resource configuration of the base station during the present time step, whether present values of the KPIs correspond to the KPI constraints and determining, based on whether the present values of the KPIs correspond to the KPI constraints, a KPI budget;
for a future time step, subsequent to the present time step:
determining, for each of a plurality of future resource configurations of the base station, a probability that future values of the KPIs correspond to the KPI constraints and determining a future energy consumption of the future resource configuration;
determining a next resource configuration of the base station based on a combination of the future energy consumption of each of the plurality of future resource configurations, the probability that, for each of the plurality of future resource configurations, the future values of the KPIs correspond to the KPI constraints, and the KPI budget; and
causing one or more resources of the base station to be reconfigured based on the next resource configuration.

2. The computer-implemented method of claim 1, wherein determining the next resource configuration includes solving a long-term stochastic problem to minimize an objective function indicative of a linear combination of the future energy consumption at the base station and a penalty for violation of the KPI budget.

3. The computer-implemented method of claim 1, further comprising determining, based on whether the present values of the KPIs correspond to the KPI constraints, a frequency of a correspondence between the present value of the KPIs and the KPI constraints, and determining a minimum acceptable frequency of the correspondence between the present values of the KPIs and the KPI constraints.

4. The computer-implemented method of claim 3, wherein determining the KPI budget includes determining a difference between the frequency of the correspondence between the present value of the KPIs and the KPI constraints and the minimum acceptable frequency of the correspondence between the present values of the KPIs and the KPI constraints.

5. The computer-implemented method of claim 1, wherein determining, for each of the plurality of future resource configurations, the probability that the future values of the KPIs correspond to the KPI constraints is based on the present resource configuration, a plurality of present radio conditions, and a present network load.

6. The computer-implemented method of claim 1, wherein causing the one or more resources associated with the base station to be reconfigured based on the next resource configuration further comprises activating or deactivating a frequency band.

7. The computer-implemented method of claim 1, wherein causing the one or more resources of the base station to be reconfigured based on the next resource configuration includes activating or deactivating at least one radiating element of an antenna system of the base station.

8. The computer-implemented method of claim 1, wherein determining the next resource configuration is based on a resource configuration switch penalty that limits switching of the present resource configuration to the next resource configuration.

9. The computer-implemented method of claim 8, wherein the next resource configuration is determined based on the combination of the future energy consumption, the penalty for violation of the KPI budget and the resource configuration switch penalty.

10. The computer-implemented method of claim 1, wherein a sliding time window is divided into a plurality of time steps including the present time step and the future time step subsequent to the present time step.

11. An apparatus comprising:
at least one processor; and
at least one memory storing instructions that, when executed by the at least one processor, causes the apparatus at least to:
determine a plurality of key performance indicators (KPIs) indicative of a plurality of operating parameters of a base station;
determine a plurality of KPI constraints corresponding to the plurality of KPIs and indicative of constraints on the plurality of operating parameters of the base station;
for a present time step:
determine, for a present resource configuration of the base station during the present time step, whether present values of the KPIs correspond to the KPI constraints and determine, based on whether the present values of the KPIs correspond to the KPI constraints, a KPI budget;
for a future time step, subsequent to the present time step:
determine, for each of a plurality of future resource configurations of the base station, a probability that future values of the KPIs correspond to the KPI constraints and determine a future energy consumption of the future resource configuration;
determine a next resource configuration of the base station based on a combination of the future energy consumption of each of the plurality of future resource configurations, the probability that, for each of the plurality of future resource configurations, the future values of the KPIs correspond to the KPI constraints, and the KPI budget; and
cause one or more resources of the base station to be reconfigured based on the next resource configuration.

12. The apparatus of claim 11, wherein the instructions to determine the next resource configuration further include instructions to solve a long-term stochastic problem to minimize an objective function indicative of a linear combination of the future energy consumption at the base station and a penalty for violation of the KPI budget.

13. The apparatus of claim 11, wherein the instructions further cause the apparatus to determine, based on whether the present values of the KPIs correspond to the KPI constraints, a frequency of a correspondence between the present value of the KPIs and the KPI constraints, and determine a minimum acceptable frequency of the correspondence between the present values of the KPIs and the KPI constraints.

14. The apparatus of claim 13, wherein the instructions to determine the KPI budget further include instructions to determine a difference between the frequency of the correspondence between the present value of the KPIs and the KPI constraints and the minimum acceptable frequency of the correspondence between the present values of the KPIs and the KPI constraints.

15. The apparatus of claim 11, wherein the instructions to determine, for each of the plurality of future resource configurations, the probability that the future values of the KPIs correspond to the KPI constraints are based on the present resource configuration, a plurality of present radio conditions, and a present network load.

16. The apparatus of claim 11, wherein the instructions to cause the one or more resources associated with the base station to be reconfigured based on the next resource configuration further cause the apparatus to activate or deactivate a frequency band.

17. The apparatus of claim 11, wherein the instructions to cause the one or more resources of the base station to be reconfigured based on the next resource configuration further cause the apparatus to activate or deactivate at least one radiating element of an antenna system of the base station.

18. The apparatus of claim 11, wherein the instructions to determine the next resource configuration are based on a resource configuration switch penalty that limits switching of the present resource configuration to the next resource configuration.

19. The apparatus of claim 18, wherein the next resource configuration is determined based on the combination of the future energy consumption, the penalty for violation of the KPI budget and the resource configuration switch penalty.

20. The apparatus of claim 11, wherein a sliding time window is divided into a plurality of time steps including the present time step and the future time step subsequent to the present time step.

21-40. (canceled)
